(19) United States
(12) Patent Application Publication
(10) Pub. No.: US 2026/0141865 A1
(43) Pub. Date: May 21, 2026

(54) DISPLAY DEVICE AND METHOD FOR OPERATING THE SAME

(71) Applicant: LG Display Co., Ltd., Seoul (KR)

(72) Inventors: Sung Su HAN, Paju-si (KR); Byeong Seong SO, Paju-si (KR); Do Young JUNG, Paju-si (KR)

(73) Assignee: LG Display Co., Ltd., Seoul (KR)

(21) Appl. No.: 19/284,320

(22) Filed: Jul. 29, 2025

(30) Foreign Application Priority Data
Nov. 15, 2024 (KR) 10-2024-0162906

(51) Int. Cl. G09G 3/3291; G09G 3/3266

(52) U.S. Cl. CPC G09G 3/3291; G09G 3/3266; G09G 2300/0819; G09G 2310/0286; G09G 2310/08; G09G 2320/0233; G09G 2320/064

(57) ABSTRACT

Disclosed is a display device, including: a display panel on which a pixel is arranged; a gate driver configured to apply a scan signal and a light emission signal to the pixel; and a data driver configured to apply a data voltage to the pixel through a data line and receive a signal output from the pixel through a readout line, and the data driver may include: a sensing driver configured to generate sensing data based on a sensing signal output through the readout line; and a switching element having one end connected to the readout line and another end connected to the sensing driver or a voltage source in response to a switching control signal, and a method for operating the display device.

### CROSS REFERENCE TO RELATED APPLICATION

The present application claims the benefit of and priority to Korea Patent Application No. 10-2024-0162906, filed Nov. 15, 2024, the entire contents of which are incorporated herein by reference for all purposes.

### BACKGROUND

### 1. Technical Field

The present disclosure relates to a display device and a method for operating the display device.

### 2. Description of Related Art

A pixel of a display device includes a light emitting diode and a driving circuit configured to drive the light emitting diode. The light emitting diode may be selected variously according to the kinds of the display device, however, recently, an organic light emitting diode (OLED) having a fast response speed and excellent light emission efficiency, luminance, viewing angle, contrast range and color reproducibility is actively used.

The light emitting diode has an anode electrode connected to a driving circuit, and a cathode electrode connected to a low potential driving voltage. Such a light emitting diode may receive a driving current in correspondence with a voltage of the anode electrode determined through the driving circuit and may emit light at luminance corresponding to the driving current.

In a display device including a light emitting diode, at the time of low grayscale expression, erroneous images such as spots, afterimages, or a change in a color coordinate may occur. In order to solve such an erroneous image phenomenon, a method for driving pulse width modulation has been researched and developed. The PWM driving can minimize afterimages at the time of low grayscale expression by adjusting a ratio of light emission and the non-emission of the light emitting diode, that is, the light emission duty ratio, improve low grayscale expression ability by improving luminance uniformity, and reduce leakage currents of the pixels.

The description of related art should not be considered prior art merely because it is mentioned in or associated with this section. The description of related art includes information that describes one or more aspects of the subject technology, and the description in this section does not limit the scope of the invention.

### SUMMARY

Embodiments provide a display device which controls a duty ratio of light emission of the light emitting diode during the light emission period when the pixel is driven, and a method for driving the display device.

Embodiments provide a display device which controls a current path such that an amount of a current of the driving current flowing through the driving transistor can be maintained to be constant during the PWM driving, and a method for driving the display device.

Embodiments control the light emission duty ratio by controlling the driving current to flow to the light emitting diode or the readout line and maintain an amount of the driving current to be constant during the PWM driving.

Embodiments provide a display device which prevents drop of the high potential driving voltage during the PWM driving by implementing the PWM driving through a transistor electrically connecting the high potential driving voltage to one electrode of the driving transistor and connected between the readout line and another electrode of the driving transistor, and a method for driving the display device.

Embodiments provide a display device which prevents an unstable voltage variation of major nodes by controlling a current path of the driving current flowing to the light emitting diode during the light emission period, and a method for driving the display device.

Embodiments provide a display device which minimizes the current leakage by using an oxide semiconductor thin film transistor.

One embodiment is a display device, including: a display panel on which a pixel is arranged; a gate driver configured to apply a scan signal and a light emission signal to the pixel; and a data driver configured to apply a data voltage to the pixel through a data line and receive a signal output from the pixel through a readout line.

The data driver may include: a sensing driver configured to generate sensing data based on a sensing signal output through the readout line; and a switching element having one end connected to the readout line and another end connected to the sensing driver or a voltage source in response to a switching control signal.

The switching element may electrically connect the readout line and the voltage source to each other during display-driving, and the switching element may electrically connect the readout line and the sensing driver to each other during sensing-driving.

The pixel may include: a light emitting diode; a driving transistor having a first electrode connected to a high potential driving voltage line, a second electrode connected to a first node, and a gate electrode connected to a second node; a switching transistor connected between the data line and the second node and having a gate electrode configured to receive a first scan signal; a readout transistor connected between the driving transistor and the readout line and having a gate electrode configured to receive a fourth scan signal; and a first light emission transistor connected between the high potential driving voltage line and the first electrode of the driving transistor and having a gate electrode configured to receive a first light emission signal.

The readout transistor may have one electrode connected to the first electrode or the second electrode of the driving transistor, and another electrode connected to the readout line.

The fourth scan signal may be applied such that a turn-on level and a turn-off level are alternately switched at least once during a light emission period in which the first light emission transistor is turned on within one frame.

When the fourth scan signal is applied to the readout transistor in a turn-off level, a driving current flowing from the high potential driving voltage line to the driving transistor may be applied to the light emitting diode, and when the fourth scan signal is applied to the readout transistor in a turn-on level, the driving current may be output to the readout line through the readout transistor.

The pixel may further include a second light emission transistor connected between the first node and the light emitting diode and having a gate electrode configured to receive a second light emission signal, and the second light emission signal may be applied such that a turn-on level and a turn-off level of the second light emission signal are alternately switched at least once during a light emission period in which the first light emission transistor is turned on within one frame.

The fourth scan signal may be applied such that a turn-on level and a turn-off level of the fourth scan signal are alternately switched at least once during a light emission period in which the first light emission transistor is turned on within one frame, and during the light emission period, a turn-off period of the second light emission signal and a turn-on period of the fourth scan signal may overlap, and a turn-on period of the second light emission signal and a turn-off period of the fourth scan signal may overlap.

The pixel may further include: an initialization transistor connected between a reference voltage line and the second node and having a gate electrode configured to receive a second scan signal; an anode initialization transistor connected between the light emitting diode and an initialization voltage line and having a gate electrode configured to receive a third scan signal; a first capacitor connected between the first node and the second node; and a second capacitor connected between the high potential driving voltage line and the first node.

The display panel may include a display area in which the pixel is disposed and a non-display area disposed adjacent to the display area, and the gate driver may include: shift registers disposed on left and right sides of the display area in the non-display area, and configured in a form symmetrical to each other on left and right sides.

The shift registers may include: a first shift register configured to output the first scan signal; a second shift register configured to output the second scan signal; a third shift register configured to output the third scan signal; a fourth shift register configured to output the fourth scan signal; a fifth shift register configured to output the first light emission signal; and a sixth shift register configured to output the second light emission signal.

The first to fourth shift registers may be disposed to be sequentially away from the display area, the fifth to sixth shift registers may be disposed to be sequentially away from the display area, and the second to fourth shift registers may be disposed to be adjacent to one among the fifth and sixth shift registers.

The gate driver may include: a modulation driver configured to generate a pulse width modulation signal based on a light emission duty ratio, and apply the pulse width modulation signal to the fourth shift register or the sixth shift register as a start signal.

Another embodiment is a method for operating the display device, including: applying the switching control signal in a first level in a display period; and applying the switching control signal in a second level which is different from the first level in a sensing period.

The display period may include: an initializing operation in which the gate driver switches the second scan signal, the third scan signal, and the second light emission signal in a turn-on level; a sampling operation in which the gate driver switches the second light emission signal to a turn-off level and apply the first light emission signal in a turn-on level; a programming operation in which the gate driver switches the second scan signal and the first light emission signal to a turn-off level, switches the first scan signal to a turn-on level, and allowing the data driver to apply the data voltage; an on-bias operation in which the gate driver switches the first scan signal to a turn-off level and switches the second light emission signal to a turn-on level; and a light emitting operation in which the gate driver switches the third scan signal to a turn-off level and switches the first light emission signal to a turn-on level, and the fourth scan signal may be applied such that a turn-on level and a turn-off level of the fourth scan signal are alternately switched at least once during the light emitting operation.

The second light emission signal may be applied such that a turn-on level and a turn-off level of the second light emission signal are alternately switched at least once during the light emitting operation, and a turn-off period of the second light emission signal and a turn-on period of the fourth scan signal may overlap, and a turn-on period of the second light emission signal and a turn-off period of the fourth scan signal may overlap.

The sensing period may include: an initializing operation in which the gate driver applies the second scan signal, the fourth scan signal, and the first light emission signal in a turn-on level, and a sensing initialization voltage is applied to the readout line; and a sensing operation in which the application of the sensing initialization voltage is stopped and a sensing signal is output to the readout line.

Still another embodiment is a display device, including: a pixel; and a data driver configured to apply a data voltage to the pixel.

The data driver may include: a sensing driver configured to generate sensing data based on a sensing signal output through a readout line; and a switching element having one end connected to the readout line and another end connected to the sensing driver or a voltage source in response to a switching control signal, and the pixel may include: a light emitting diode; a driving transistor having a first electrode connected to a high potential driving voltage line, a second electrode connected to a first node, and a gate electrode connected to a second node; a switching transistor connected between a data line and the second node and having a gate electrode configured to receive a first scan signal; a readout transistor connected between the driving transistor and the readout line and having a gate electrode configured to receive a fourth scan signal; and a first light emission transistor connected between the high potential driving voltage line and the first electrode of the driving transistor and having a gate electrode configured to receive a first light emission signal.

The pixel may further include: a second light emission transistor connected between the first node and the light emitting diode and having a gate electrode configured to receive a second light emission signal; an initialization transistor connected between a reference voltage line and the second node and having a gate electrode configured to receive a second scan signal; an anode initialization transistor connected between the light emitting diode and an initialization voltage line and having a gate electrode configured to receive a third scan signal; a first capacitor connected between the first node and the second node; and a second capacitor connected between the high potential driving voltage line and the first node.

The display device and the method for operating the display device according to the embodiments may prevent generation of an unwanted unstable voltage variation at major nodes inside the pixel when operating the pixel.

The display device and the method for operating the display device according to the embodiments may improve the image quality by preventing a voltage drop phenomenon of the high potential driving voltage in the light emission period.

The display device and the method for operating the display device according to the embodiments may solve a problem of spots such as mura becoming visible or distortion of luminance in the low grayscale and the like in the light emission period.

The display device and the method for operating the display device according to the embodiments may minimize current leakage by using the oxide semiconductor thin film transistor.

Additional features, advantages, and aspects of the present disclosure are set forth in part in the description that follows and in part will become apparent from the present disclosure or may be learned by practice of the inventive concepts provided herein. Other features, advantages, and aspects of the present disclosure may be realized and attained by the descriptions provided in the present disclosure, or derivable therefrom, and the claims hereof as well as the drawings. It is intended that all such features, advantages, and aspects be included within this description, be within the scope of the present disclosure, and be protected by the following claims. Nothing in this section should be taken as a limitation on those claims. Further aspects and advantages are discussed below in conjunction with embodiments of the present disclosure.

It is to be understood that both the foregoing description and the following description of the present disclosure are examples, and are intended to provide further explanation of the disclosure as claimed.

### BRIEF DESCRIPTION OF THE DRAWINGS

The accompanying drawings, which are included to provide a further understanding of the present disclosure, are incorporated in and constitute a part of this present disclosure, illustrate aspects and embodiments of the present disclosure, and together with the description serve to explain principles and examples of the disclosure.

FIG. 1 is a block diagram illustrating a configuration of a display device according to an embodiment.

FIG. 2 is a diagram illustrating a method for operating a display device according to an embodiment.

FIG. 3 is a block diagram illustrating a configuration of a data driver according to an embodiment.

FIG. 4 is a circuit diagram of a pixel according to a first embodiment.

FIG. 5 is a diagram illustrating a method for operating a pixel illustrated in FIG. 4 according to an embodiment.

FIGS. 6 to 11 are diagrams illustrating a method for operating a pixel illustrated in FIG. 5 step by step.

FIG. 12 is a diagram illustrating a method for operating a pixel illustrated in FIG. 4 according to another embodiment.

FIGS. 13 and 14 are diagrams illustrating a method for operating a pixel illustrated in FIG. 12 step by step.

FIG. 15 is a diagram illustrating a method for operating a pixel illustrated in FIG. 4 according to still another embodiment.

FIG. 16 is a circuit diagram of a pixel according to a second embodiment.

FIG. 17 is a diagram illustrating a method for operating a pixel illustrated in FIG. 16 according to an embodiment.

FIGS. 18 and 19 are diagrams illustrating a method for operating a pixel illustrated in FIG. 17 step by step.

FIG. 20 is a diagram illustrating a method for operating a pixel illustrated in FIG. 16 according to another embodiment.

FIG. 21 is a block diagram illustrating a configuration of a gate driver according to an embodiment.

FIG. 22 is a diagram illustrating a connection relationship between stage circuits of a gate driver according to an embodiment.

FIG. 23 is a timing diagram illustrating an example of a signal output by a shift register illustrated in FIG. 22.

Throughout the drawings and the detailed description, unless otherwise described, the same drawing reference numerals should be understood to refer to the same elements, features, and structures. The sizes, lengths, and thicknesses of layers, regions and elements, and depiction thereof may be exaggerated for clarity, illustration, and/or convenience.

### DETAILED DESCRIPTION

Hereinafter, embodiments of the disclosure will be described with reference to the drawings. In this specification, when it is mentioned that a component (or, an area, a layer, a part, etc.) is referred to as being “on,” “connected to” or “combined to” another component, this means that the component may be directly on, connected to, or combined to the other component or a third component therebetween may be present.

Like reference numerals refer to like elements. Additionally, in the drawings, the thicknesses, proportions, and dimensions of components are exaggerated for effective description. “And/or” includes all of one or more combinations defined by related components.

It will be understood that the terms “first” and “second” are used herein to describe various components but these components should not be limited by these terms. The above terms are used only to distinguish one component from another. For example, a first component may be referred to as a second component and vice versa without departing from the scope of the disclosure. The singular expressions include plural expressions unless the context clearly dictates otherwise. For example, an element may be one or more elements. An element may include a plurality of elements. The word “exemplary” is used to mean serving as an example or illustration. Embodiments are example embodiments. Aspects are example aspects. In one or more implementations, “embodiments,” “examples,” “aspects,” and the like should not be construed to be preferred or advantageous over other implementations. An embodiment, an example, an example embodiment, an aspect, or the like may refer to one or more embodiments, one or more examples, one or more example embodiments, one or more aspects, or the like, unless stated otherwise. Further, the term “may” encompasses all the meanings of the term “can.”

In addition, terms such as “below,” “the lower side,” “on,” and “the upper side” are used to describe a relationship of configurations shown in the drawing. The terms are described as a relative concept based on a direction shown in the drawing.

In various embodiments of the disclosure, the term “include,” “comprise,” “including,” or “comprising,” specifies a property, a fixed number, a step, a process, an element and/or a component, or a combination thereof, but does not exclude presence or addition of other properties, fixed numbers, steps, processes, elements and/or components, or a combination thereof.

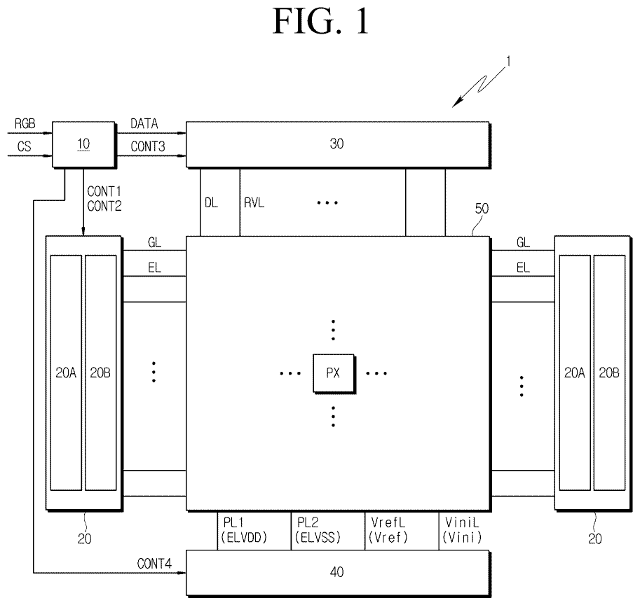

FIG. 1 is a block diagram illustrating a configuration of a display device according to an embodiment.

Referring to FIG. 1, a display device 1 includes a timing controller 10, a gate driver 20, a data driver 30, a power supply unit 40, and a display panel 50.

The timing controller 10 may control an operation timing of the gate driver 20 and the data driver 30. The timing controller 10 may receive an image signal RGB and a control signal CS from an external host system, and the like. The image signal RGB may include a plurality of grayscale data. The control signal CS may include, for example, a data enable signal, a horizontal synchronization signal, a vertical synchronization signal and a main clock signal.

The timing controller 10 processes the image signal RGB and the control signal CS to be suitable to operational conditions of the display panel 50, and may generate and output image data DATA, a gate driving control signal CONT1, an emission driving control signal CONT2, a data driving control signal CONT3, and a power supply control signal CONT4. The control signal CS may include a data enable signal, a horizontal synchronization signal, a vertical synchronization signal and a main clock, etc. The gate driving control signal CONT1 and/or the emission driving control signal CONT2 may include scan timing control signals such as a gate start pulse, a gate shift clock, and a gate output enable signal. The data driving control signal CONT3 may include a source sampling clock, a polarity control signal, a source output enable signal, and the like.

The timing controller 10 may be disposed on a source printed circuit board to which the data driver 30 is bonded, and a control printed circuit board connected through a connection medium of a flexible flat cable (FFC) or a flexible printed circuit (FPC). For example, the timing controller 10 may be connected to the data driver 30 through one or more predefined interfaces such as an Embedded clock P-P Interface (EPI), a serial peripheral interface (SPI), and the like to send and receive data. Similarly, the timing controller 10 can transmit signals to, and receive signals from, the gate driver 20 via one or more predefined interfaces.

The gate driver 20 may include a scan driving circuit 20A configured to generate scan signals based on the gate driving control signal CONT1 and the emission driving control signal CONT2 output from the timing controller 10. The scan driving circuit 20A may provide the generated scan signals to the pixels PX through a plurality of scan lines GL. In an embodiment, one pixel PX may be configured to receive a plurality of scan signals having different waveforms. In such an embodiment, the scan driving circuit 20A may provide the plurality of scan signals to the pixels PX through the scan lines GL corresponding thereto, respectively.

The gate driver 20 may further include a light emission driving circuit 20B configured to generate light emission control signals based on the gate driving control signal CONT1 and the emission driving control signal CONT2 output from the timing controller 10. The light emission driving circuit 20B may provide the generated light emission control signals to the pixels PX through light emission lines EL.

The gate driver 20 may include various gate driving circuits, and the gate driving circuits can be directly formed on the substrate. The gate driver 20 may be configured in a Gate-In-Panel form in which the gate driver 20 is mounted on the display panel 50. The gate driver 20 may be disposed on one side of the display panel 50, or on both sides (for example, left and right sides) of the display panel 50 as illustrated. According to a driving method, a panel design manner, and the like, as illustrated, the gate driver 20 may be disposed on both sides (for example, left and right sides) of the display panel 50, or may be connected to two or more side surfaces among four side surfaces (e.g., the upper edge, the lower edge, a left edge, and a right edge) of the display panel 50, but is not limited thereto. Alternatively, the gate driver 20 may be disposed on both sides (for example, upper and lower edges) of the display panel 50.

The data driver 30 may generate data signals based on the data driving control signal CONT3 and image data DATA output from the timing controller 10. The data driver 30 may be a circuit for driving the plurality of data lines DL, and can supply data signals to the plurality of data lines DL. The data driver 30 may provide the generated data signals to the pixels PX through a plurality of data lines DL.

In an embodiment, the data driver 30 may be further connected to the pixels PX through a readout line RVL. The data driver 30 may sense a state of the pixels PX based on an electric signal fed-back from the pixels PX through the readout line RVL. In such an embodiment, the timing controller 10 may select a pixel row and/or a pixel PX subjected to sensing of a characteristic value during a predetermined period. The timing controller 10 may control the gate driver 20 to apply a scan signal and/or light emission signal in a certain level and/or having a certain pattern to a selected sensing pixel.

In response to the scan signal and/or light emission signal, when a sensing signal is output from the pixel PX, the data driver 30 may generate sensing data Vsen based on the sensing signal. The timing controller 10 may generate image data DATA compensated from the outside based on the sensing data Vsen obtained through the data driver 30. The compensation of the image data DATA may be the compensation for one or more among a threshold voltage, mobility of the driving transistor provided in the pixel PX, and/or an operating point voltage of an organic light emitting diode. The image quality deterioration such as spots in the display panel 50 may be improved as compensated image data DATA is supplied to the data driver 30.

The data driver 30 may be configured as a source drive circuit or a source drive IC. The data driver 30 may be connected to a bonding pad of the display panel 50 in a Tape Automated Bonding (TAB) manner, or a Chip on Glass (COG) manner, or disposed on the display panel 50 directly, and according to cases, may be integrated into the display panel 50, but is not limited thereto. Alternatively, the data driver 30 may be connected to a bonding pad of the display panel 50 in a chip-on-panel (COP) technique, or connected to the display panel 50 by a chip-on-film (COF) technique, without being limited thereto.

The power supply unit 40 may generate a high potential driving voltage ELVDD and a low potential driving voltage ELVSS to be provided to the display panel 50 based on the power supply control signal CONT4. The power supply unit 40 may provide the generated driving voltages ELVDD and ELVSS to the pixels PX through corresponding power lines PL1 and PL2. In addition, the power supply unit 40 may further generate a reference voltage Vref and/or an initialization voltage Vini required for driving the pixel PX and provide it to the pixels PX through a corresponding voltage line VrefL and ViniL. Such a power supply unit 40 may be referred to as a Power Management IC (PMIC).

On the display panel 50, a plurality of pixels PX (or referred to as sub-pixels) may be disposed. The pixels may be disposed, for example, in a matrix form on the display panel 50. The pixels disposed in one pixel row are connected to the same scan line GL and light emission line EL, and the pixels disposed in one pixel column are connected to the same data line DL. The pixels PX may emit light at luminance corresponding to a data signal and a scan signal supplied through the scan line GL and the data line DL in response to a light emission control signal applied through the light emission line EL.

In an embodiment, each pixel PX may display one color among red, green and blue. In another embodiment, each pixel PX may display one color among cyan, magenta and yellow. In various embodiments, each pixel PX may display one color among red, green, blue and white.

In some aspects, the display device 1 may be a mobile terminal such as a notebook computer, a smart phone, a tablet, or the like, or a monitor, a television (TV), or the like, without being limited thereto. Such devices may be configured in various types, sizes, and shapes. The display device 1 according to aspects of the present disclosure are not limited thereto, and may include various types, sizes, and shapes of the display devices configured to display information or images.

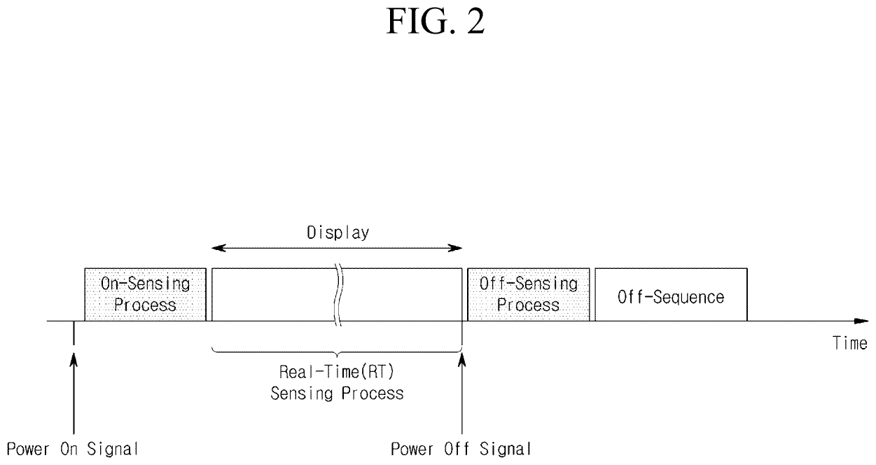

FIG. 2 is a diagram illustrating a method for operating a display device according to an embodiment.

Referring to FIGS. 1 and 2 together, the display device 1 according to an embodiment may sense a characteristic value of the driving transistor inside each pixel PX disposed on the display panel 50, when a power-on signal is generated. Such a sensing operation is referred to as an on-sensing process.

In addition, before an off-sequence such as power down proceeds when a power-off signal is generated, the display device 1 may sense a characteristic value of the driving transistor inside each pixel PX disposed on the display panel 50. Such a sensing operation is referred to as an off-sensing process.

In addition, before a power-off signal is generated since a power-on signal is generated, the display device 1 may sense a characteristic value of the driving transistor inside each pixel PX disposed on the display panel 50 during the display-driving. Such a sensing operation is referred to as a real-time sensing process. Such a real-time sensing process may be conducted in each blank period between active periods based on the vertical synchronization signal.

The display device 1 may display an image through the pixels PX disposed on the display panel 50 during the display-driving. The display driving may be conducted on a unit of a frame which is defined based on the vertical synchronization signal. Each frame may include an active period and a blank period.

In the active period, the display device 1 may initialize a node voltage of each of the pixels PX, program the data voltage Vdata in synchronization with the scan signal, and control to emit light in response to the light emission signal.

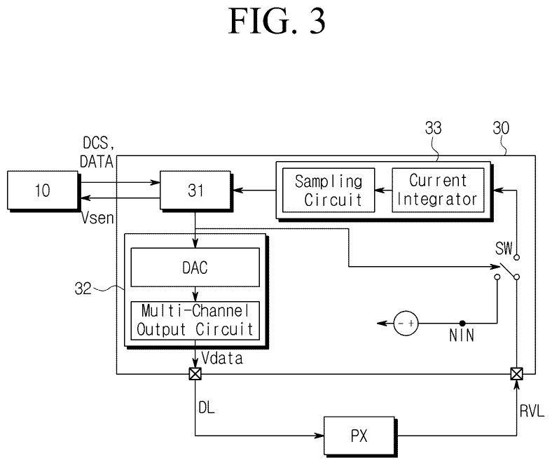

FIG. 3 is a block diagram illustrating a configuration of the data driver according to an embodiment.

Referring to FIG. 3, the data driver 30 may include a communication unit 31, a display driver 32, and a sensing driver 33.

The communication unit 31 may communicate data with the timing controller 10 according to a preset communication protocol. For example, the communication unit 31 may communicate with the timing controller 10 using an Embedded Point-to-point Interface (EPI). In the EPI protocol, the timing controller 10 serializes a data control signal DCS and the image data DATA, inserts clock information into the data and converts the data on a unit of a packet. In addition, the timing controller 10 transmits the converted data packet to the data driver 30 in a point-to-point manner. The communication unit 31 may process the data packet received from the timing controller 10 and output the processed data packet to another component. For example, the communication unit 31 may be configured as a serial-to-parallel converter configured to parallelize the data packet received from the timing controller 10 and output the parallelized data packet.

The display driver 32 may supply data signals to the plurality of data lines DL. The display driver 32 may generate the data voltage Vdata based on the data control signal DCS and the image data DATA received through the communication unit 31, and output the data voltage Vdata to the data line DL through an output channel CH. The display driver 32 may include a digital-to-analog converter DAC configured to convert the image data into a data voltage Vdata in an analog signal form, and a Multi-Channel Output Circuit (for example, a buffer circuit) configured to output the data voltage Vdata to a corresponding output channel CH.

The sensing driver 33 may process a sensing signal (for example, a sensing current) applied from the pixel PX through the readout line RVL and generate sensing data Vsen. The sensing driver 33 may include a current integrator configured to integrate a sensing current, and a sampling circuit configured to sample the integrated sensing current and generate a sampling signal. The sensing driver 33 may convert a sampling signal into sensing data Vsen in a digital form, and may transmit the converted sensing data Vsen to the timing controller 10 through the communication unit 31.

The timing controller 10 may generate a compensation value of the sensing data Vsen obtained from the data driver 30, and transmit the image data DATA compensated for the compensation value to the data driver 30. Deterioration of the pixels PX may be compensated because the display driver 32 of the data driver 30 generates the data voltage Vdata based on the compensated image data DATA and outputs the data voltage Vdata to the data line DL.

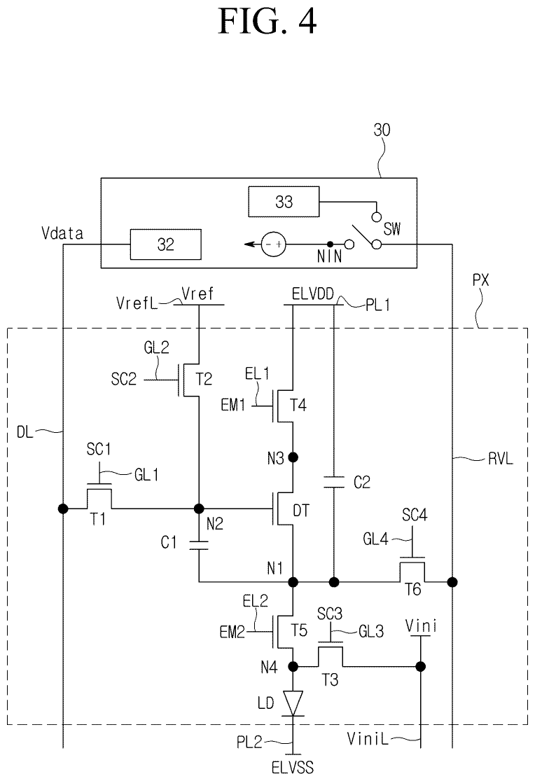

The data driver 30 may further include a switching element SW configured to control a connection state of the readout line RVL. The switching element SW may be configured such that one end thereof is connected to the readout line RVL, and the other end is connected to the sensing driver 33 or a current input node NIN in response to a switching control signal. The current input node NIN may be connected to a predetermined voltage source (or a current source), and may be connected to, for example, a voltage lower than an operating point voltage of the light emitting diode LD (FIG. 4), or a ground voltage, but is not limited thereto.

A connection state of the switching element SW may be controlled through a switching control signal received through the data control signal DCS and the like. As one example, the switching element SW may be controlled through a switching control signal received through the data control signal DCS and the like so as to control the connection between the readout line RVL and the sensing driver 33 or the current input node NIN. For example, in response to a switching control signal in a first level, the switching element SW may electrically connect the readout line RVL and the sensing driver 33 to each other, and in response to a switching control signal in a second level, the switching element SW may electrically connect the readout line RVL and the current input node NIN to each other. Here, the first level is one among a high level and a low level, and the second level is the other one among the high level and the low level.

For example, during the sensing-driving described referring to FIG. 2, the switching control signal is applied in the first level and may control the switching element SW to electrically connect the readout line RVL and the sensing driver 33 to each other. In addition, for example, during the light emission period of the display-driving described referring to FIG. 2, the switching control signal is applied in the second level and may control the switching element SW to electrically connect the readout line RVL and the current input node NIN to each other.

When the switching element SW electrically connects the readout line RVL and the sensing driver 33 to each other, a sensing signal output through the readout line RVL may be applied to the sensing driver 33. In addition, when the switching element SW electrically connects the readout line RVL and the current input node NIN to each other, a current Isc4 (FIG. 4) output through the readout line RVL may be applied to the current input node NIN.

FIG. 4 is a circuit diagram of the pixel according to a first embodiment.

Referring to FIG. 4, the pixel PX according to an embodiment may include a driving transistor DT, a light emitting diode LD connected to the driving transistor DT, and a control circuit configured to control an amount of a driving current Id to be applied to the light emitting diode LD through the driving transistor DT. For example, the control circuit may include first to sixth transistors T1 to T6, and first and second capacitors C1 and C2.

A first electrode of the driving transistor DT is configured to receive a high potential driving voltage ELVDD through a third node N3 (connected to a high potential driving voltage line PL1), and a second electrode thereof is connected to a first node N1. A gate electrode of the driving transistor DT is connected to a second node N2. The driving transistor DT may be turned on according to a voltage applied to the second node N2 and may control an amount of the driving current flowing to the light emitting diode LD. For example, one of the third node N3 and the first node N1 of the driving transistor DT may be a source node of the driving transistor DT, and the other thereof may be a drain node of the driving transistor DT.

The first electrode of the first transistor T1 is connected to the data line DL, and the second electrode thereof is connected to the gate electrode of the driving transistor DT through the second node N2. A gate electrode of a first transistor T1 may be connected to the first scan line GL1 and may receive a first scan signal SC1. The first transistor T1 may be turned on or off according to the first scan signal SC1 applied to a first scan line GL1. When the first transistor T1 is turned on according to the first scan signal SC1 applied to a first scan line GL1, a data voltage Vdata output from the data driver 30 may be delivered and applied to the data line DL to the second node N2. Such a first transistor T1 may be referred to as a switching transistor.

A first electrode of the second transistor T2 is configured to receive a reference voltage Vref (connected to a reference voltage line VrefL), and a second electrode thereof is connected to the second node N2. A gate electrode of the second transistor T2 may be connected to a second scan line GL2 and may receive a second scan signal SC2. The second transistor T2 may be turned on according to the second scan signal SC2 applied to the second scan line GL2, and may deliver a reference voltage Vref to the second node N2. Such a second transistor T2 may be referred to as an initialization transistor.

A first electrode of the third transistor T3 is configured to receive a initialization voltage Vini (connected to a initialization voltage line ViniL), and a second electrode thereof is connected to the anode electrode of the light emitting diode LD through a fourth node N4. A gate electrode of the third transistor T3 may be connected to a third scan line GL3 and may receive a third scan signal SC3. The third transistor T3 may be turned on or off according to the third scan signal SC3 applied to the third scan line GL3. When third transistor T3 is turned on according to the third scan signal SC3 applied to the third scan line GL3, an initialization voltage Vini may be delivered to the anode electrode of the light emitting diode LD. Such a third transistor T3 may be referred to as an anode initialization transistor.

A first electrode of the fourth transistor T4 is configured to receive the high potential driving voltage ELVDD (connected to the high potential driving voltage line PL1), and a second electrode thereof is connected to the driving transistor DT through the third node N3. A gate electrode of the fourth transistor T4 may be connected to a first light emission line EL1 and may receive a first light emission signal EM1. The fourth transistor T4 may be turned on or off in response to the first light emission signal EM1 applied to the first light emission line EL1. The fourth transistor T4 may connect the high potential driving voltage line PL1 and the driving transistor DT to each other when the fourth transistor T4 is turned on in response to the first light emission signal EM1 applied to the first light emission line EL1.

A first electrode of a fifth transistor T5 may be connected to the driving transistor DT through the first node N1, and a second electrode thereof may be connected to the light emitting diode LD through the fourth node N4. A gate electrode of the fifth transistor T5 may be connected to a second light emission line EL2, and may receive a second light emission signal EM2. The fifth transistor T5 may be turned on or off in response to the second light emission signal EM2 applied to the second light emission line EL2. The fifth transistor T5 may connect the driving transistor DT and the light emitting diode LD to each other when the fifth transistor T5 is turned on in response to the second light emission signal EM2 applied to the second light emission line EL2.

When the fourth transistor T4 and the fifth transistor T5 are turned on, a current path is formed between the high potential driving voltage ELVDD and the low potential driving voltage ELVSS, and a driving current may flow from the high potential driving voltage ELVDD to the driving transistor DT. The driving current may be applied to the light emitting diode LD, and the light emitting diode LD may emit light. For example the light emitting diode LD may emit light at luminance corresponding to an amount of the driving current Id applied thereto. Such fourth transistor T4 and the fifth transistor T5 may be referred to as light emitting transistors.

A first electrode of a sixth transistor T6 may be connected to the first node N1, and a second electrode thereof may be connected to the readout line RVL. A gate electrode of the sixth transistor T6 may be connected to a fourth scan line GL4 and may receive a fourth scan signal SC4. The sixth transistor T6 may be turned on or off according to the fourth scan signal SC4 applied to the fourth scan line GL4. The sixth transistor T6 may be turned on according to the fourth scan signal SC4 applied to the fourth scan line GL4, and may electrically connect the first node N1 and the readout line RVL. During the sensing-driving described referring to FIG. 2, through the sixth transistor T6 turned on, a sensing signal (for example, a sensing voltage or a sensing current) to which a voltage characteristic or a current characteristic of the first node N1 is reflected may be output to the readout line RVL. In addition, with respect to the display-driving described referring to FIG. 2, during the light emission period which will be described below, a driving current to be applied to the first node N1 may be output to the readout line RVL through the sixth transistor T6 which is turned on. Such a sixth transistor T6 may be referred to as a readout transistor.

The sensing signal or the driving current output to the readout line RVL may be applied to the data driver 30 connected to the readout line RVL. According to the control of the switching element described referring to FIG. 3, the sensing signal may be applied to the sensing driver 33 of the data driver 30, and the driving current may be applied to the current input node NIN of the data driver 30.

The first capacitor C1 is connected between the first node N1 and the second node N2. The first capacitor C1 may store a voltage corresponding to a voltage difference between the first node N1 and the second node N2. For example, the first capacitor C1 may store a voltage corresponding to a voltage difference between the data voltage Vdata applied to the data line DL and the second node N2, and maintain the stored voltage during one frame, thereby stabilizing a voltage of the gate electrode (that is, the second node N2) of the driving transistor DT. Such a first capacitor C1 may be referred to as a storage capacitor.

The second capacitor C2 is connected between the first node N1 and the high potential driving voltage ELVDD. The second capacitor C2 may store a voltage corresponding to a voltage difference between the first node N1 and the high potential driving voltage ELVDD. For example, the second capacitor C2 may store a voltage corresponding to a voltage difference between a threshold voltage charged in the first node N1 and the high potential driving voltage ELVDD, thereby compensating deterioration of the driving transistor DT. Such a second capacitor C2 may be referred to as a compensation capacitor.

The anode electrode of the light emitting diode LD may be connected to the fourth node N4, and the cathode electrode thereof may be connected to the low potential driving voltage ELVSS.

When the driving transistor DT, the fourth transistor T4, and the fifth transistor T5 are turned on, a current path is formed between the high potential driving voltage ELVDD and the low potential driving voltage ELVSS, and a driving current Id may flow from the high potential driving voltage ELVDD to the driving transistor DT. The driving current Id may be applied to the light emitting diode LD, and the light emitting diode LD may emit light at luminance corresponding to an amount of the driving current Id applied thereto. Such fourth transistor T4 and the fifth transistor T5 may be referred to as light emitting transistors.

In the embodiment illustrated in FIG. 4, the pixel PX may include an oxide semiconductor thin film transistor. The oxide semiconductor thin film transistor includes a gate electrode, a source electrode, and a drain electrode. The oxide semiconductor thin film transistor has an active layer formed of an oxide semiconductor. Here, the oxide semiconductor may be set as an amorphous oxide semiconductor or a crystalline oxide semiconductor. The oxide semiconductor thin film transistor may be configured as an n-type transistor. However, the present embodiment is not limited thereto. The oxide semiconductor thin film transistor may be formed through a low temperature process and has a lower charge mobility than that of the low temperature poly-silicon (LTPS) thin film transistor. Such an oxide semiconductor thin film transistor has an excellent off current characteristic.

However, the present embodiment is not limited thereto. In various other embodiments, the pixel PX as a whole may be configured as an oxide semiconductor thin film transistor, or may be configured as a hybrid type including both the LTPS thin film transistor and an oxide semiconductor thin film transistor.

The LTPS thin film transistor includes a gate electrode, a source electrode, and a drain electrode. The LTPS thin film transistor has an active layer formed of poly silicon. Such an LTPS thin film transistor may be configured as a P-type thin film transistor. The LTPS thin film transistor has a high electron mobility, and therefore, has a fast driving characteristic.

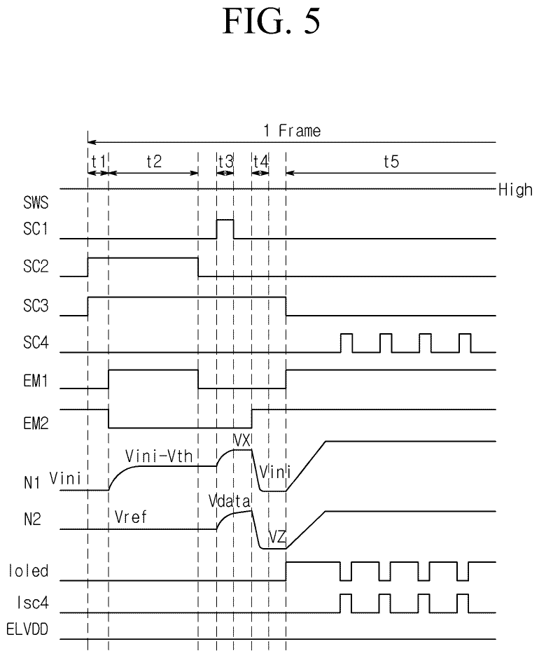

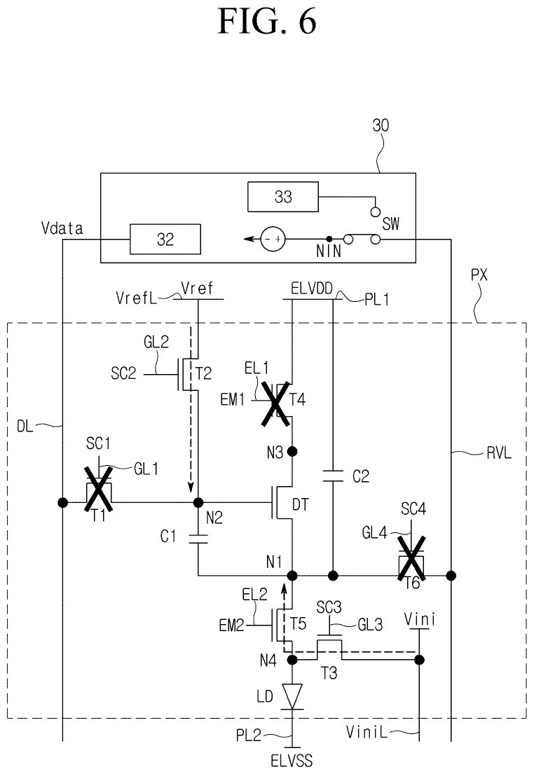

FIG. 5 is a diagram illustrating a method for operating the pixel illustrated in FIG. 4 according to an embodiment. In more detail, FIG. 5 illustrates the method for operating the pixel during the display-driving. During the display-driving, the switching element SW may electrically connect the readout line RVL and the current input node NIN to each other in response to the switching control signal SWS in the second level, for example, a high level. FIGS. 6 to 11 are diagrams illustrating the method for operating the pixel illustrated in FIG. 5 step by step.

During the display-driving, the pixel PX may be driven on a unit of a frame. One frame may include an initialization period t1, a sampling period t2, a programming period t3, an on-bias period t4, and a light emission period t5.

Referring to FIGS. 5 and 6 together, in the initialization period t1, major nodes of the pixel PX are initialized. In more detail, in the initialization period t1, the second scan signal SC2 and the third scan signal SC3 in a turn-on level (for example, a high level) are applied, and the second transistor T2 and the third transistor T3 are turned on. In addition, in the initialization period t1, the second light emission signal EM2 in a turn-on level is applied, and the fifth transistor T5 is turned on. For example, the initialization period t1, the first transistor T1, the fourth transistor T4 and the sixth transistor T6 may be turned off.

When the reference voltage Vref is applied to the second node N2 through the second transistor T2 which is turned on, the gate node of the driving transistor DT may be initialized to the reference voltage Vref. The reference voltage Vref may be a positive voltage in a low level, and may be a voltage corresponding to black luminance, but is not limited thereto.

When the initialization voltage Vini is applied to the fourth node N4 through the third transistor T3 which is turned on, the anode electrode of the light emitting diode LD may be initialized to the initialization voltage Vini. The initialization voltage Vini may be applied further to the first node N1 through the fifth transistor T5 which is turned on, thereby further initializing a voltage of the source node of the driving transistor DT. The initialization voltage Vini may be a voltage which is the same as or different from the reference voltage Vref. For example, the initialization voltage Vini may be a voltage lower than the reference voltage Vref, or a negative voltage, but is not limited thereto.

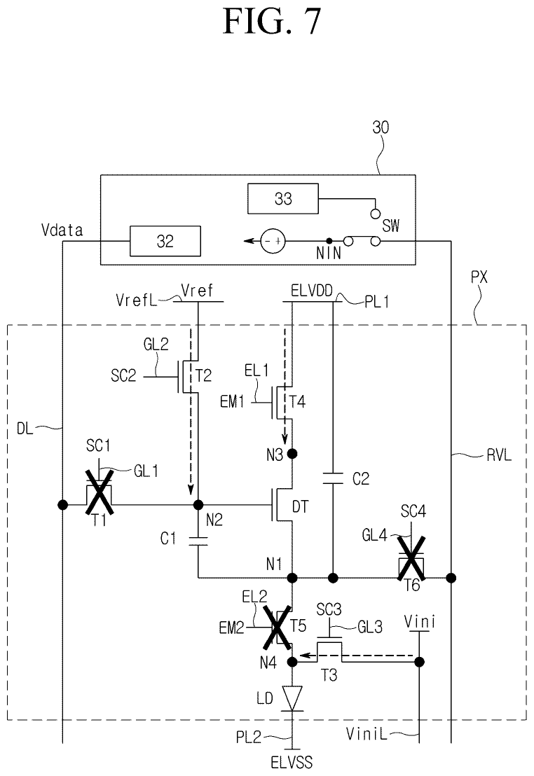

Referring to FIGS. 5 and 7 together, in the sampling period t2, the threshold voltage Vth of the driving transistor DT is sampled. In more detail, in the sampling period t2, the first light emission signal EM1 may switch over to a turn-on level and the fourth transistor T4 may be turned on. In addition, the second light emission signal EM2 may switch over to a turn-off level and the fifth transistor T5 may be turned off. For example, in the sampling period t2, the first light emission signal EM1 may switch over to a turn-on level from the turn-off level of the initialization period t1. In this case, the fourth transistor T4 may be turned on in response to the first light emission signal EM. For example, the sampling period t2, the first transistor T1, the fifth transistor T5 and the sixth transistor T6 may be turned off.

When the high potential driving voltage ELVDD is applied to the third node N3 through the fourth transistor T4 which is turned on, the high potential driving voltage ELVDD may be applied to a drain node of the driving transistor DT. A reference voltage Vref is applied to the gate node of the driving transistor DT through the second transistor T2. A source node of the driving transistor DT gets into a voltage variable state (a source-follower state).

Accordingly, in the sampling period t2, the driving transistor DT may be turned on and operate in a source follower manner. That is, the driving transistor DT may supply a drain-source current to the first node N1 by the time when a gate-source voltage reaches a threshold voltage Vth of the driving transistor DT. A voltage of the first node N1 may increase gradually from the initialization voltage Vini, and may converge to a voltage Vref−Vth corresponding to a difference between the reference voltage Vref and the threshold voltage Vth.

The first capacitor C1 stores a voltage corresponding to a difference between a voltage of the second node N2 and a voltage of the first node N1. After the driving transistor DT is saturated, the first capacitor C1 may store a threshold voltage Vth corresponding to a difference between the reference voltage Vref and the voltage Vref-Vth of the first node N1.

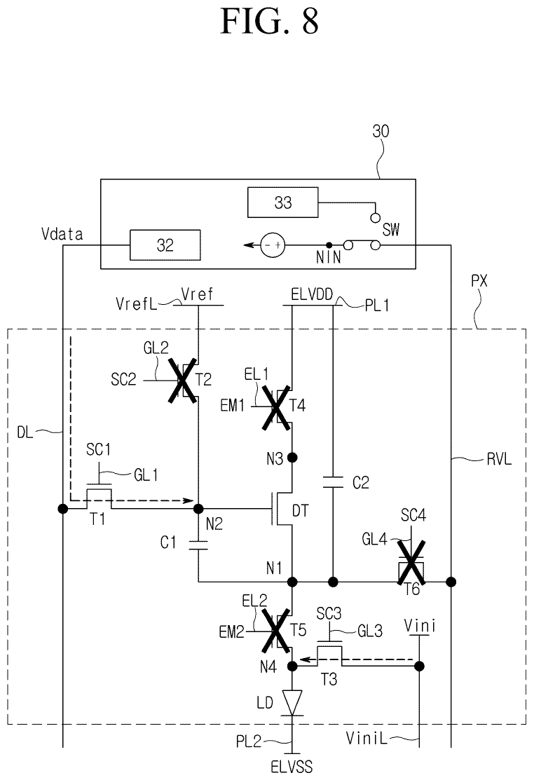

Referring to FIGS. 5 and 8 together, in the programming period t3, the data voltage Vdata is programmed into the pixel PX. In more detail, in the programming period t3, the second scan signal SC2 and the first light emission signal EM1 switch over to a turn-off level, thereby the second transistor T2 and the fourth transistor T4 are turned off. In addition, in the programming period t3, the first scan signal SC1 is applied in a turn-on level, thereby the first transistor T1 is turned on. For example, in the programming period t3, the second transistor T2 and the fourth transistor T4 may switch over to a turn-off level from the turn-on level of the sampling period t2. Also, the first transistor T1 may switch over to a turn-on level from the turn-off level of the sampling period t2.

When the data voltage Vdata is applied to the second node N2 through the first transistor T1 which is turned on, the data voltage Vdata may be applied to the gate node of the driving transistor DT. A voltage of the gate node of the driving transistor DT may rise to a voltage corresponding to the data voltage Vdata.

A source node of the driving transistor DT is coupled to the gate node through the first and second capacitors C1 and C2. Therefore, a voltage of the first node N1 may rise to VX from a voltage Vref−Vth−ELVDD which is previously set in correspondence with a voltage rise of the gate node. In an embodiment, VX may be Vref−Vth+{(CST1)/(CST1+Coled)}×(Vdata−Vref). Here, CST1 is a capacity of the first capacitor C1, and Coled is a parasitic capacitance between the anode electrode and the cathode electrode of the light emitting diode LD.

In the programming period t3, a gate-source voltage of the driving transistor DT is set to be higher than the threshold voltage Vth, that is, set to an on-condition. For example, the gate-source voltage Vgs of the driving transistor DT may be Vref−Vth+{(CST1)/(CST1+CST2)}×(Vdata−Vref)−Vref. Here, CST2 is a capacity of the second capacitor C2.

In the above course, the electron mobility of the driving transistor DT may be compensated. The smaller the electron mobility gets, the greater the gate-source voltage of the driving transistor is set, and on contrary, the greater the electron mobility gets, the smaller the gate-source voltage of the driving transistor DT is set.

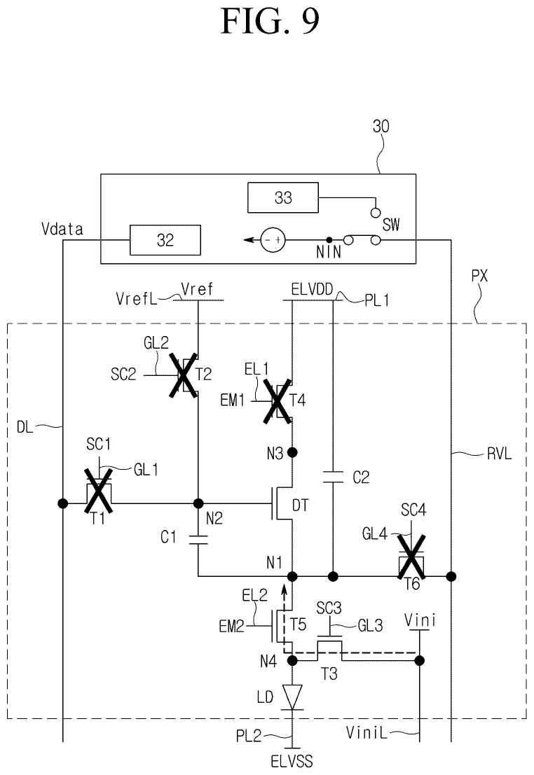

Referring to FIGS. 5 and 9 together, in an on-biasing period t4, a voltage of the first node N1, which is a source node of the driving transistor DT, is biased. In more detail, in the on-bias period t4, the first scan signal SC1 switches over to a turn-off level. In addition, the second light emission signal EM2 in a turn-on level may be applied. Accordingly, the first transistor T1 is turned off, and the fifth transistor T5 is turned on. For example, in the on-biasing period t4, the first scan signal SC1 switches over to a turn-off level from a turn-on level of the programming period t3, and the second light emission signal EM2 switches over to a turn-on level from a turn-off level of the programming period t3. In this case, the first transistor T1 is turned off in response to the first scan signal SC1, and the fifth transistor T5 is turned on in response to the second light emission signal EM2.

The initialization voltage Vini applied through the third transistor T3 in a turn-on state may be applied to the source node of the driving transistor DT through the fifth transistor T5 which is turned on. As a voltage of source node is lowered to the initialization voltage Vini from VY, the on-bias stress of the light emitting diode LD may be reduced. The gate node of the driving transistor DT is coupled to the source node through the first and second capacitors C1 and C2. Therefore, a voltage of the second node N2 may drop to VZ in correspondence with a voltage drop of the source node. In an embodiment, VZ may be Vdata−[Vref−Vth+{(cst1)/(cst1+cst2)}*(Vdata−Vref)].

That is, the gate-source voltage of the driving transistor set in the programming period t3 is maintained the same in the on-bias period t4.

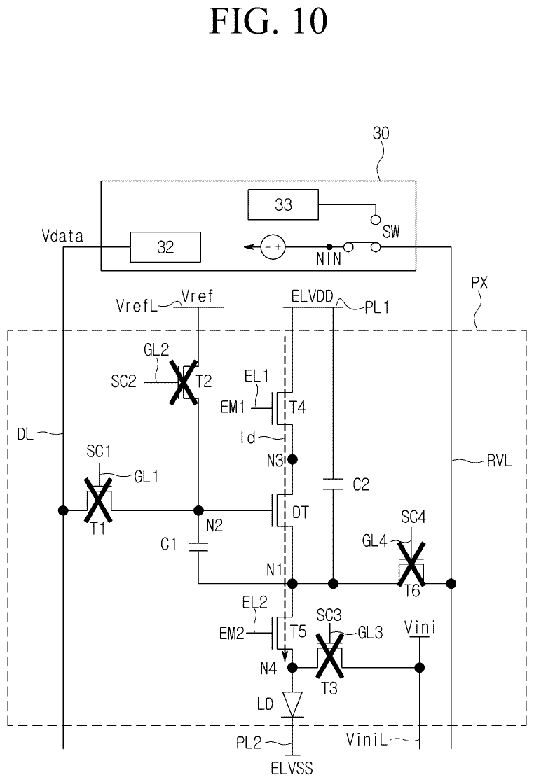

Referring to FIGS. 5 and 10 together, in the light emission period t5, the light emitting diode LD which is turned on may emit light at luminance corresponding to the programmed voltage. In more detail, in the light emission period t5, the third scan signal SC3 switches over to a turn-off level, and the first light emission signal EM1 switches over to a turn-on level, thereby the third transistor T3 may be turned off and the fourth transistor T4 may be turned on. For example, in the light emission period t5, the third scan signal SC3 switches over to a turn-off level from a turn-on level of the on-bias period t4, and the first light emission signal EM1 switches over to a turn-on level from a turn-off level of the on-bias period t4. In this case, the third transistor T3 may be turned off in response to the third scan signal SC3, and the fourth transistor T4 may be turned on in response to the first light emission signal EM1.

Through the fourth transistor T4 and the fifth transistor T5 which are turned on, a driving current Id may flow from the high potential driving voltage ELVDD to the light emitting diode LD via the driving transistor DT. A voltage of the source node of the driving transistor DT rises to the operating point voltage of the light emitting diode LD by the driving current Id. At this instance, the gate node is coupled to the source node through the first capacitor C1 and the second capacitor C2, therefore, a voltage of the gate node rises as well. As a result, the gate-source voltage of the driving transistor DT set in the programming period t3 is maintained in the light emitting period t5. In particular, the second capacitor C2 may prevent a change in the gate-source voltage by complementing an insufficient holding ability of the first capacitor C1.

The light emitting diode LD emits light by the driving current Id when the voltage of the source node of the driving transistor DT becomes equal to the operating point voltage.

In an embodiment, in the light emission period t5, the PWM driving may be conducted. That is, in the light emission period t5, the light emitting diode LD may be controlled such that a light emitting state and a non-emitting state are alternately switched according to a duty ratio determined through the timing controller 10 and the like.

To this end, the pixel PX may be controlled such that application and non-application of the driving current Id to the light emitting diode LD are alternately switched. In more detail, as illustrated in FIG. 5, in the light emission period t5 in which the fourth transistor T4 is turned on by the first light emission signal EM1, the fourth scan signal SC4 is applied such that a turn-on level and a turn-off level of the fourth scan signal SC4 are alternately switched at least once. A time length of the turn-on level of the fourth scan signal SC4 may be determined according to a light emission duty ratio. As a time in which the fourth scan signal SC4 is maintained in a turn-on level gets longer, the light emission duty ratio of the light emitting diode LD may be reduced. The light emission duty ratio may be in a range of about 20% to 90%, but is not limited thereto. For example, as illustrated in FIG. 5, in the light emission period t5, a turn-on level and a turn-off level of the fourth scan signal SC4 are alternately switched at least once, and the sixth transistor T6 is turned on or off in response to the fourth scan signal SC4 at least once. The light emitting diode LD may emit light or not based on the turning-on/turning-off of the sixth transistor T6. For example, the PWM driving is implemented through turning-on/turning-off of the sixth transistor T6.

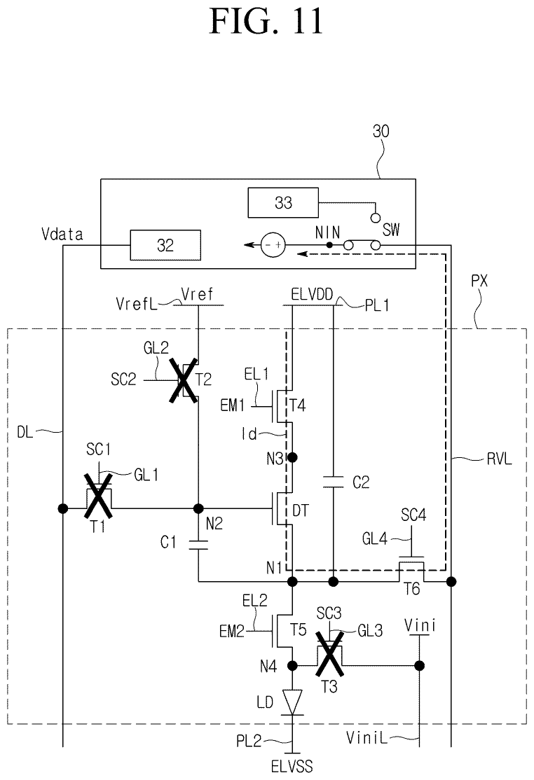

The sixth transistor T6 may alternately switch turning-on and turning-off in the light emission period t5 in response to the fourth scan signal SC4. While the sixth transistor T6 is turned off, as illustrated in FIG. 10, the driving current Id is applied to the light emitting diode LD, and the light emitting diode LD may emit light. On contrary, while the sixth transistor T6 is turned on, as illustrated in FIG. 11, the driving current Id is applied to the readout line RVL through the sixth transistor T6. The driving current Id applied to the readout line RVL may be applied to the current input node NIN of the data driver 30. That is, while the sixth transistor T6 is turned on, the driving current Id is not applied to the light emitting diode LD, and the light emitting diode LD may not emit light. A relationship between a current Ioled flowing in the light emitting diode LD and a current Isc4 passing through the sixth transistor T6 during the PWM driving is illustrated in FIG. 5 based on the driving current Id.

To make the driving current Id be applied to the readout line RVL rather than to the light emitting diode LD, the current input node NIN may be set to a lower voltage than the voltage of the anode electrode of the light emitting diode LD. For example, a voltage of the input node NIN may be set to a voltage lower than the operating point voltage of the light emitting diode LD, or a ground voltage, but is not limited thereto.

In such an embodiment, the PWM driving is implemented through turning-on/turning-off of the sixth transistor T6, and the first light emission signal EM1 and the second light emission signal EM2 may maintain a turn-on state. In addition, the driving current Id generated through the driving transistor DT may continually flow without cut-off of the current path. Therefore, during the PWM driving, voltages of the first to third nodes N1, N2, and N3 may be stably maintained. In particular, a voltage of the third node N3 is stably maintained as the high potential driving voltage ELVDD, thereby the voltage drop phenomenon of the high potential driving voltage ELVDD may be prevented.

Meanwhile, through the PWM driving described above, in the pixel PX, afterimages are minimized in the low grayscale expression, and luminance uniformity with respect to the low grayscale is improved, thereby the low grayscale expression can be improved and the leakage current can be reduced.

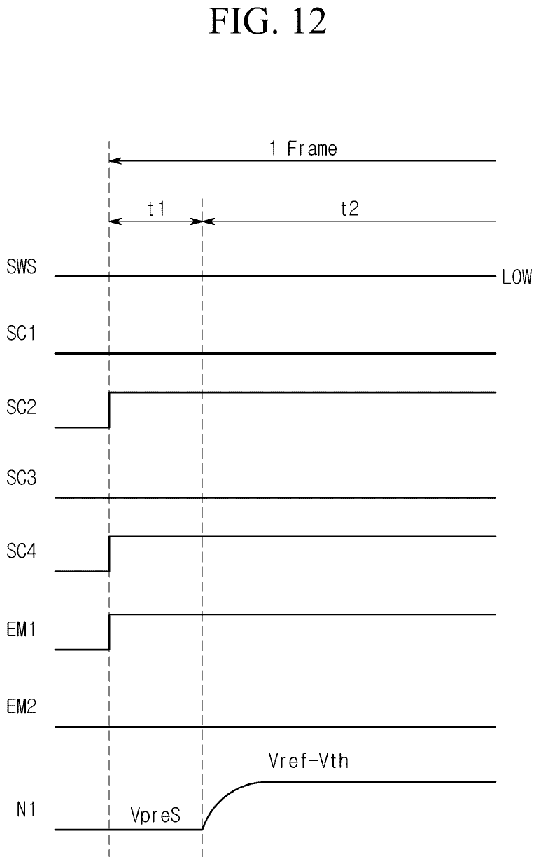

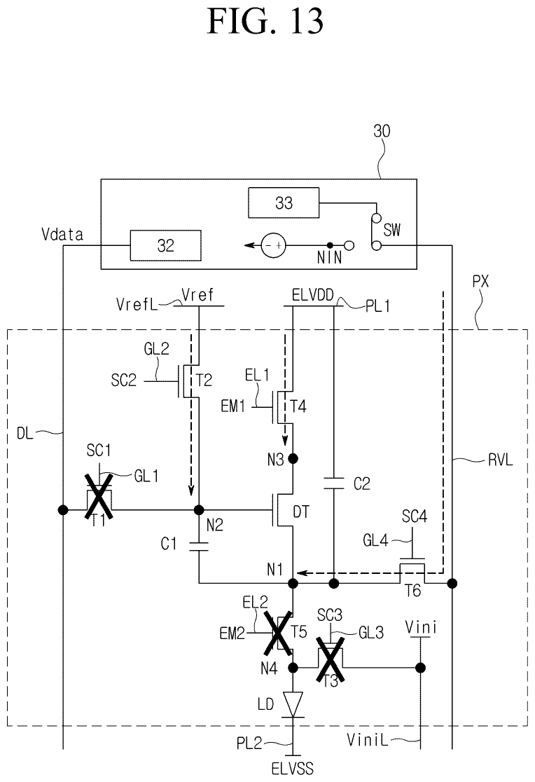

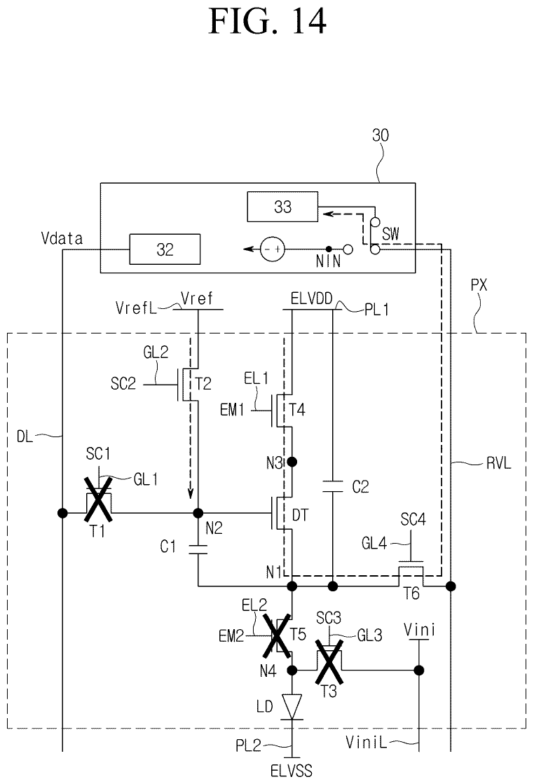

FIG. 12 is a diagram illustrating a method for operating a pixel illustrated in FIG. 4 according to another embodiment. In more detail, FIG. 12 shows a method for operating the pixel PX during the sensing-driving. During the sensing-driving, the switching element SW electrically connects the readout line RVL and the sensing driver 33 to each other in response to the switching control signal SWS in a low level. FIGS. 13 and 14 are diagrams illustrating the method for operating the pixel illustrated in FIG. 12 step by step.

During the display-driving, the pixel PX may be driven on a unit of a frame. One frame may include an initialization period t1 and a sensing period t2. The pixel PX may be initialized in the initialization period t1, and a characteristic value of the pixel PX may be sensed in the sensing period t2.

Referring to FIGS. 12 and 13 together, in the initialization period t1, major nodes of the pixel PX are initialized. In more detail, in the initialization period t1, the second scan signal SC2 and the fourth scan signal SC4 in a turn-on level (for example, a high level) are applied, and the second transistor T2 and the sixth transistor T6 are turned on. In addition, in the initialization period t1, the first light emission signal EM1 in a turn-on level is applied, and the fourth transistor T4 is turned on. Referring to FIGS. 12 and 13 together, in the initialization period t1, the first scan signal SC1, the third scan signal SC3 and the second light emission signal EM2 in a turn-off level (for example, a low level) are applied, and the first transistor T1, the third transistor T3 and the fourth transistor T5 are turned off.

When the reference voltage Vref is applied to the second node N2 through the second transistor T2 which is turned on, the gate node of the driving transistor DT may be initialized to the reference voltage Vref. The reference voltage Vref may be a positive voltage in a low level, and may be a voltage corresponding to black luminance, but is not limited thereto.

An initialization voltage VpreS for sensing to be applied to the readout line RVL is applied to the first node N1 through the fourth transistor T4 which is turned on, thereby a source electrode of the driving transistor DT may be initialized.

The high potential driving voltage ELVDD is applied to the third node N3 through the fifth transistor T5 which is turned on, and a drain electrode of the driving transistor DT may be initialized to the high potential driving voltage ELVDD.

Referring to FIGS. 12 and 14 together, in the sensing period t2, the threshold voltage Vth of the driving transistor DT is sensed. In more detail, in the sensing period t2, supply of the initialization voltage VpreS for sensing to the readout line RVL stops. Then, a voltage of the first node N1, that is, a voltage of the source electrode of the first node N1 gets into a voltage-variable state (a source-follower state). For example, in the sensing period t2, the levels of the first scan signal SC1, the second scan signal SC2, the third scan signal SC3, the fourth scan signal SC4, the first light emission signal EM1 and the second light emission signal EM2 may be the same as those of these signals in the initialization period t1, but is not limited thereto.

The driving transistor DT may supply the drain-source current to the first node N1 by the time when the gate-source voltage reaches the threshold voltage Vth of the driving transistor DT. A voltage of the first node N1 may increase gradually from the initialization voltage VpreS for sensing, and may converge to a voltage Vref−Vth corresponding to a difference between the reference voltage Vref and the threshold voltage Vth.

An electrical signal corresponding to a voltage of the first node N1, that is, a sensing signal may be delivered to the sensing driver 33 through the readout line RVL. The sensing driver 33 may generate the sensing data Vsen by converting the sensing signal, and deliver the sensing data Vsen to the timing controller 10.

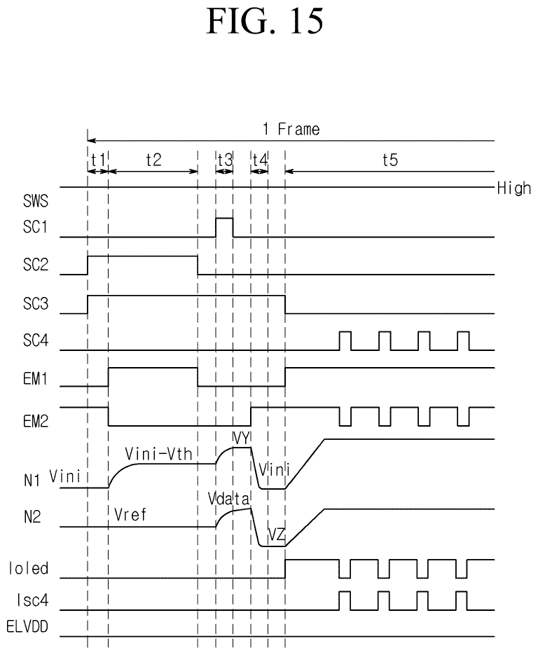

FIG. 15 is a diagram illustrating a method for operating a pixel illustrated in FIG. 4 according to still another embodiment. In more detail, FIG. 15 shows a method for driving the pixel PX during the display-driving. During the display-driving, the switching element SW may electrically connect the readout line RVL and the current input node NIN to each other in response to the switching control signal SWS in the second level, for example, a high level.

In comparison with FIG. 5, in the embodiment in FIG. 15, in the light emission period t5 in which the fourth transistor T4 is turned on by the first light emission signal EM1, the second light emission signal EM2 is applied such that a turn-on level and a turn-off level of the second light emission signal EM2 are alternately switched at least once. A time length of the turn-on level of the second light emission signal EM2 may be determined according to a light emission duty ratio. As a time in which the second light emission signal EM2 is maintained in a turn-off level gets longer, the light emission duty ratio of the light emitting diode LD may be reduced. For example, the fifth transistor T5 may alternately switch turning-on and turning-off at least once in the light emission period t5 in response to the second light emission signal EM2. The light emitting diode LD may emit light or not based on the turning-on/turning-off of the fifth transistor T5.

The fifth transistor T5 may alternately switch turning-on and turning-off in the light emission period t5 in response to the second light emission signal EM2. While the fifth transistor T5 is turned on, the driving current Id may be applied to the light emitting diode LD via the fifth transistor T5. On contrary, while the fifth transistor T5 is turned off, the driving current Id may not be applied to the light emitting diode LD.

In such an embodiment, the second light emission signal EM2 is applied such that the second light emission signal EM2 has a form of which a voltage level is inverted with respect to the fourth scan signal SC4. In more detail, when the second light emission signal EM2 is applied in a turn-on level, the fourth scan signal SC4 is applied in a turn-off level, and when the second light emission signal EM2 is applied in a turn-off level, the fourth scan signal SC4 is applied in a turn-on level. Accordingly, when the fifth transistor T5 is turned on, the sixth transistor T6 may be turned off, and when the fifth transistor T5 is turned off, the sixth transistor T6 may be turned on.

In such an embodiment, in the non-emission period in which the driving current Id is applied to the readout line RVL through the sixth transistor T6, application of the driving current Id to the light emitting diode LD as the fifth transistor T5 is turned off may be prevented.

Meanwhile, while the second light emission signal EM2 is applied in a pulse form, the first light emission signal EM1 may maintain a turn-on state. Therefore, the high potential driving voltage ELVDD connected to the fourth transistor T4 may maintain a stable voltage level.

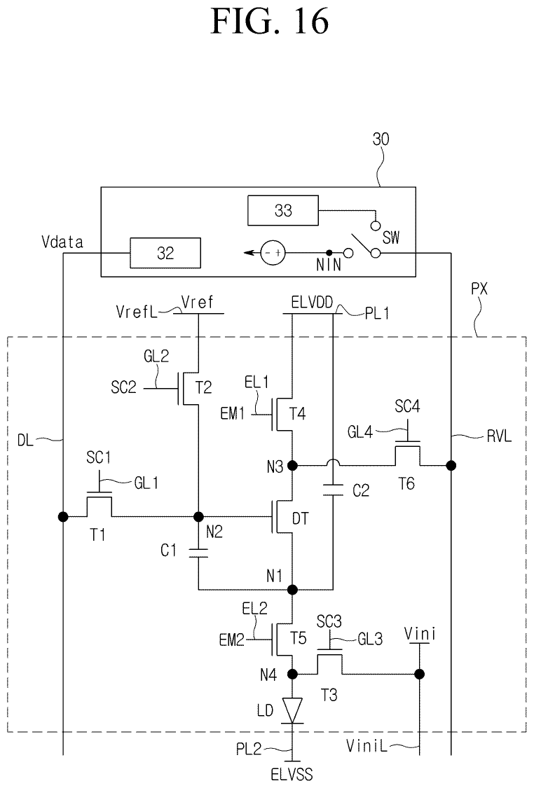

FIG. 16 is a circuit diagram of a pixel according to a second embodiment.

In comparison with the embodiment of FIG. 4, a sixth transistor T6 according to the second embodiment is connected between the third node N3 and the readout line RVL. A gate electrode of the sixth transistor T6 is connected to the fourth scan line GL4 and may receive the fourth scan signal SC4. The sixth transistor T6 is turned on or off according to the fourth scan signal SC4 to be applied to the fourth scan line GL4. For example, the sixth transistor T6 is turned on according to the fourth scan signal SC4 to be applied to the fourth scan line GL4, and may electrically connect the third node N3 and the readout line RVL to each other. For example, the sixth transistor T6 is turned on according to the fourth scan signal SC4 to be applied to the fourth scan line GL4, and may disconnect the third node N3 and the readout line RVL to each other.

In such an embodiment, in the light emission period of the display-driving, the driving current Id to be applied to the first node N1 may be output to the readout line RVL through the sixth transistor T6 which is turned on.

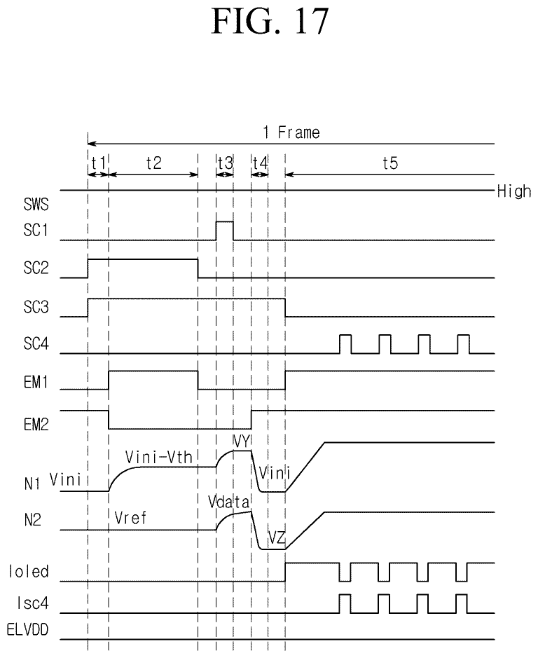

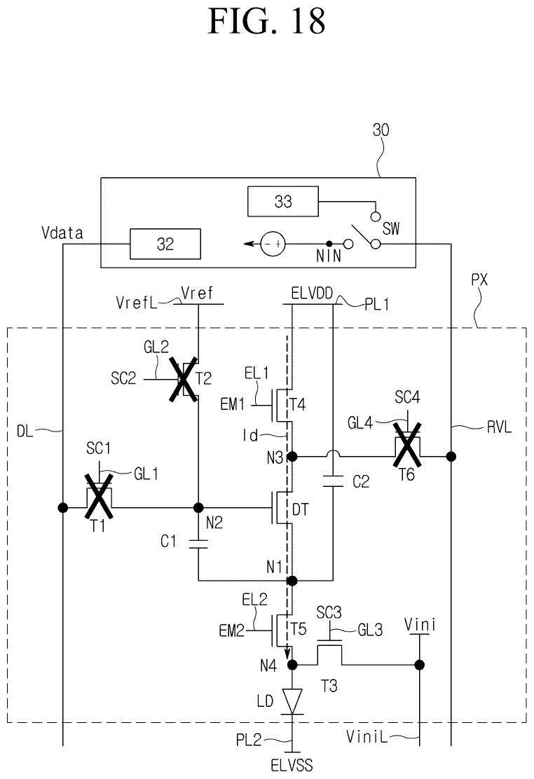

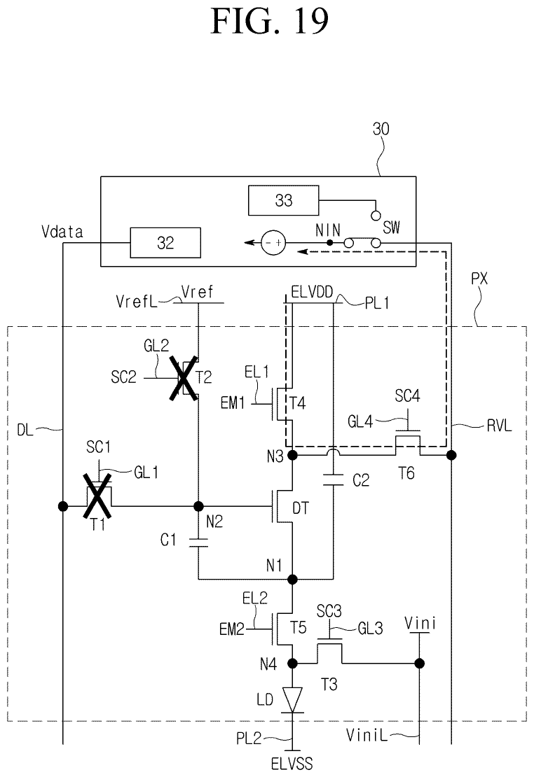

FIG. 17 is a diagram illustrating a method for operating the pixel illustrated in FIG. 16 according to an embodiment. In more detail, FIG. 17 shows a method for driving the pixel PX during the display-driving. During the display-driving, the switching element SW may electrically connect the readout line RVL and the current input node NIN to each other in response to the switching control signal SWS in the second level, for example, a high level. FIGS. 18 and 19 are diagrams illustrating the method for operating the pixel illustrated in FIG. 17 step by step.

During the display-driving, the pixel PX may be driven on a unit of a frame. One frame may include an initialization period t1, a sampling period t2, a programming period t3, an on-bias period t4, and a light emission period t5, but is not limited thereto.

Operations in the initialization period t1, the sampling period t2, the programming period t3, and the on-bias period t4 are the same as what have been described referring to FIGS. 6 to 9. Therefore, the detailed description thereof will be omitted.

Referring to FIGS. 17 and 18 together, in the light emission period t5, the light emitting diode LD which is turned on may emit light at luminance corresponding to the programmed voltage. In more detail, in the light emission period t5, the third scan signal SC3 switches over to a turn-off level, and the first light emission signal EM1 switches over to a turn-on level, thereby the third transistor T3 may be turned off and the fourth transistor T4 may be turned on. For example, in the light emission period t5, the third scan signal SC3 switches over to a turn-off level from a turn-on level of the on-bias period t4, and the first light emission signal EM1 switches over to a turn-on level from a turn-off level of the on-bias period t4, thereby the third transistor T3 may be turned off in response to the third scan signal SC3 and the fourth transistor T4 may be turned on in response to the first light emission signal EM1.

Through the fourth transistor T4 and the fifth transistor T5 which are turned on, a driving current Id may flow from the high potential driving voltage ELVDD to the light emitting diode LD via the driving transistor DT. A voltage of the source node of the driving transistor DT rises to the operating point voltage of the light emitting diode LD by the driving current Id. At this instance, the gate node is coupled to the source node through the first capacitor C1 and the second capacitor C2, therefore, a voltage of the gate node rises as well. As a result, the gate-source voltage of the driving transistor DT set in the programming period t3 is maintained in the light emitting period t5. In particular, the second capacitor C2 may prevent a change in the gate-source voltage by complementing an insufficient holding ability of the first capacitor C1.

The light emitting diode LD emits light by the driving current Id when the voltage of the source node of the driving transistor DT becomes equal to the operating point voltage.

In an embodiment, in the light emission period t5, the PWM driving may be conducted. That is, in the light emission period t5, the light emitting diode LD may be controlled such that a light emitting state and a non-emitting state are alternately switched according to a duty ratio determined through the timing controller 10 and the like.

To this end, the pixel PX may be controlled such that application and non-application of the driving current Id to the light emitting diode LD are alternately switched. In more detail, as illustrated in FIG. 17, in the light emission period t5 in which the fourth transistor T4 is turned on by the first light emission signal EM1, the fourth scan signal SC4 is applied such that a turn-on level and a turn-off level of the fourth scan signal SC4 are alternately switched at least once. A time length of the turn-on level of the fourth scan signal SC4 may be determined according to a light emission duty ratio. As a time in which the fourth scan signal SC4 is maintained in a turn-on level gets longer, the light emission duty ratio of the light emitting diode LD may be reduced. The light emission duty ratio may be in a range of about 20% to 90%, but is not limited thereto.

The sixth transistor T6 may alternately switch turning-on and turning-off in the light emission period t5 in response to the fourth scan signal SC4. For example, the sixth transistor T6 may alternately switch turning-on and turning-off at least once in the light emission period t5 in response to the fourth scan signal SC4. While the sixth transistor T6 is turned off, as illustrated in FIG. 18, the driving current Id is applied to the light emitting diode LD, and the light emitting diode LD may emit light. On contrary, while the sixth transistor T6 is turned on, as illustrated in FIG. 19, the driving current Id is applied to the readout line RVL through the sixth transistor T6. The driving current Id applied to the readout line RVL may be applied to the current input node NIN of the data driver 30. For example, while the sixth transistor T6 is turned on, the driving current Id is not applied to the light emitting diode LD, and the light emitting diode LD may not emit light. A relationship between a current Ioled flowing in the light emitting diode LD and a current Isc4 passing through the sixth transistor T6 during the PWM driving is illustrated in FIG. 17 based on the driving current Id.

The light emitting diode LD may emit light or not based on the turning-on/turning-off of the sixth transistor T6. For example, the PWM driving is implemented through turning-on/turning-off of the sixth transistor T6.

To make the driving current Id be applied to the readout line RVL rather than to the light emitting diode LD, the current input node NIN may be set to a lower voltage than the voltage of the anode electrode of the light emitting diode LD. For example, a voltage of the current input node NIN may be set to a voltage lower than the operating point voltage of the light emitting diode LD, or a ground voltage, but is not limited thereto.

In such an embodiment, the PWM driving is implemented through turning-on/turning-off of the sixth transistor T6, and the first light emission signal EM1 and the second light emission signal EM2 may maintain a turn-on state. In addition, the driving current Id generated through the driving transistor DT may continually flow without cut-off of the current path. Therefore, during the PWM driving, voltages of the first to third nodes N1, N2, and N3 may be stably maintained. In particular, a voltage of the third node N3 is stably maintained as the high potential driving voltage ELVDD, thereby the voltage drop phenomenon of the high potential driving voltage ELVDD may be prevented.

Meanwhile, through the PWM driving described above, in the pixel PX, afterimages are minimized in the low grayscale expression, and luminance uniformity with respect to the low grayscale is improved, thereby the low grayscale expression can be improved and the leakage current can be reduced.

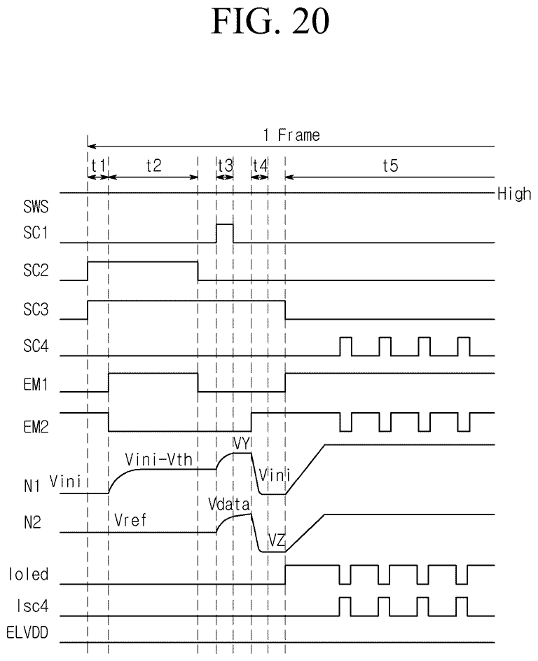

FIG. 20 is a diagram illustrating a method for operating the pixel illustrated in FIG. 16 according to another embodiment.

In comparison with the embodiment of FIG. 17, in the embodiment in FIG. 20, in the light emission period t5 in which the fourth transistor T4 is turned on by the first light emission signal EM1, the second light emission signal EM2 is applied such that a turn-on level and a turn-off level of the second light emission signal EM2 are alternately switched at least once. A time length of the turn-on level of the second light emission signal EM2 may be determined according to a light emission duty ratio. As a time in which the second light emission signal EM2 is maintained in a turn-off level gets longer, the light emission duty ratio of the light emitting diode LD may be reduced.

The fifth transistor T5 may alternately switch turning-on and turning-off in the light emission period t5 in response to the second light emission signal EM2. While the fifth transistor T5 is turned on, the driving current Id may be applied to the light emitting diode LD via the fifth transistor T5. On contrary, while the fifth transistor T5 is turned off, the driving current Id may not be applied to the light emitting diode LD. For example, the fifth transistor T5 may alternately switch turning-on and turning-off at least once in the light emission period t5 in response to the second light emission signal EM2. The light emitting diode LD may emit light or not based on the turning-on/turning-off of the fifth transistor T5.

In such an embodiment, the second light emission signal EM2 is applied such that the second light emission signal EM2 has a form of which a voltage level is inverted with respect to the fourth scan signal SC4. In more detail, when the second light emission signal EM2 is applied in a turn-on level, the fourth scan signal SC4 is applied in a turn-off level, and when the second light emission signal EM2 is applied in a turn-off level, the fourth scan signal SC4 is applied in a turn-on level. Accordingly, when the fifth transistor T5 is turned on, the sixth transistor T6 may be turned off, and when the fifth transistor T5 is turned off, the sixth transistor T6 may be turned on.

In such an embodiment, in the non-emission period in which the driving current Id is applied to the readout line RVL through the sixth transistor T6, application of the driving current Id to the light emitting diode LD as the fifth transistor T5 is turned off may be prevented.

Meanwhile, while the second light emission signal EM2 is applied in a pulse form, the first light emission signal EM1 may maintain a turn-on state. Therefore, the high potential driving voltage ELVDD connected to the fourth transistor T4 may maintain a stable voltage level.

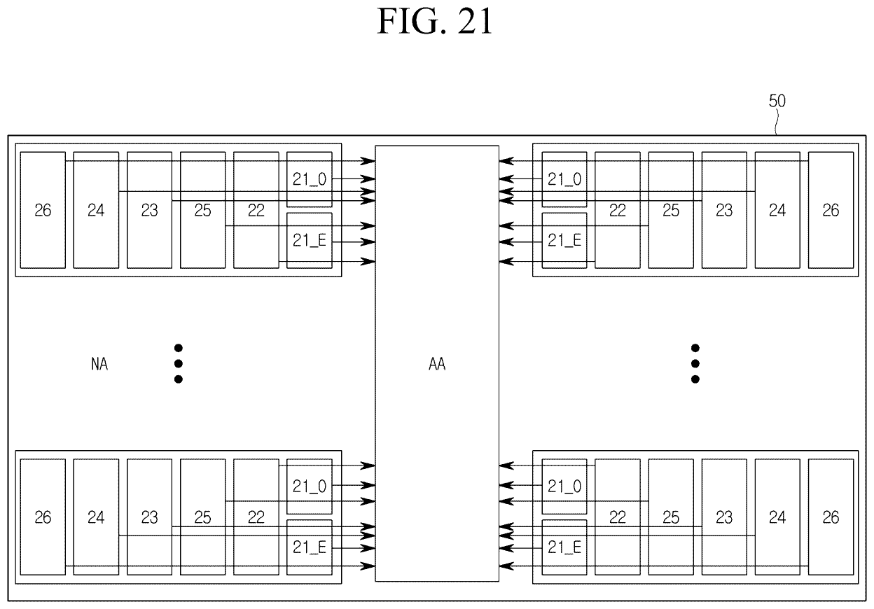

FIG. 21 is a block diagram illustrating a configuration of the gate driver according to an embodiment.

Referring to FIG. 21, the display panel 50 may include a display area AA in which an image is displayed, and a non-display area NA around the display area AA and in which an image is not displayed.

In the display area AA, an array of the pixels PX (FIG. 1) is disposed. In the non-display area, at least some of the driver may be mounted or connected. For example, the gate driver 20 may be disposed on one side or both sides (for example, a left side or a right side) of the non-display area as illustrated. The gate driver 20 disposed on both sides of the non-display area may be configured in a form in which both gate drivers 20 on the right side and the left side are symmetrical to each other (a mirrored form). Hereinafter, the configuration will be described based on the gate driver 20 disposed on the left side of the display area AA.

The gate driver 20 may be formed with first to sixth shift registers 21-1 to 26.

Referring to FIG. 1 and FIG. 4 together, the first to fourth shift registers 21-1 to 24 configure a scan driving circuit 10A, and are configured to output scan signals SC1, SC2, SC3, and SC4. For example, the first shift registers 21-1 and 21-2 sequentially output the first scan signal SC1 through the first scan lines GL1, the second shift register 22 sequentially outputs the second scan signal SC2 through the second scan lines GL2, the third shift register 23 sequentially outputs the third scan signal SC3 through the third scan lines GL3, and the fourth shift register 24 sequentially outputs the fourth scan signal SC4 through the fourth scan lines GL4.

Each of the first to fourth shift registers 21-1 to 24 may be configured as stage circuits dependently connected to each other. Each of the stage circuits is connected to corresponding scan line GL1, GL2, GL3, and GL4, and may output the scan signal SC1, SC2, SC3, and SC4 to the scan lines GL1, GL2, GL3, and GL4.

The first to fourth scan signals SC1, SC2, SC3, and SC4 may be used to drive at least one transistor provided in the pixel PX. For example, the first to fourth scan signals SC1, SC2, SC3, and SC4 may be used to program the image data DATA (FIG. 1) into the pixel PX, initialize a voltage stored in the pixel PX, compensate a characteristic of the circuit element, or control a current path of the driving current Id.

The fifth and sixth shift registers 25 and 26 configure the light emission driving circuit 20B, and are configured to output the first light emission signal EM1 and the second light emission signal EM2 (FIG. 6). For example, the fifth shift register 25 outputs the first light emission signal EM1 through the first light emission lines EL1, and the sixth shift register 26 may output the second light emission signal EM2 through the second light emission lines EL2.

The first light emission signal EM1 and the second light emission signal EM2 may be used to drive at least one transistor provided in the pixel PX. For example, the first light emission signal EM1 and the second light emission signal EM2 may be used to control light emission of the pixel PX.

The first to fourth shift registers 21-1, 21-2, 22, 23, and 24 may be disposed to be sequentially away from the display area AA. That is, the first shift register 21 may be disposed to be adjacent to the display area AA, and the fourth shift register 24 may be disposed to be away from the display area AA.

The first shift registers 21-1 and 21-2 may be divided into an odd-numbered shift register 21_1 and an even-numbered shift register 21_2. Both the odd-numbered shift register 21_1 and the even-numbered shift register 21_2 may be disposed on both sides of the display area AA. By driving the first shift registers 21-1 and 21-2 by dividing them into the odd-numbered shift register 21_1 and the even-numbered shift register 21_2, it is possible to sufficiently secure time required for application of the data voltage Vdata. In addition, by disposing the odd-numbered shift register 21_1 and the even-numbered shift register 21_2 on both sides of the display area AA, it is possible to reduce a deviation of the application time per pixel of the data voltage Vdata. Accordingly, by driving the first shift registers 21-1 and 21-2, it is possible to sufficiently secure time required for application of the data voltage Vdata, and to reduce a deviation of the application time per pixel, thereby becoming able to improve the image quality of the display panel.

The fifth and sixth shift registers 25 and 26 may be disposed to be sequentially away from the display area AA. At this instance, the first to fourth shift registers 21 to 24 may be disposed to be adjacent to one among the fifth and sixth shift registers 25 and 26. For example, the second and third shift registers 22 and 23 may be disposed to be adjacent to the fifth shift register 25, and the fourth shift register 24 may be disposed to be adjacent to the sixth shift register 26. For example, the third shift register 23 and the sixth shift register 26 may be disposed to be adjacent to the fourth shift register 24, and the first shift register 21 may be disposed to adjacent the display area AA.

The arrangements of the shift registers 21 to 26 are not limited to what are illustrated. The arrangements of the shift registers 21 to 26 may be variously changed in a possible range so as to reduce a size of the non-display area and a length and a quantity of lines according to the specification of the display panel 50.

In an embodiment, various power lines may be disposed between the display area AA and the gate driver 20. For example, the reference voltage line VrefL, the bias voltage line VARL, the high potential driving voltage line PL1, and the low potential driving voltage line PL2 may be disposed between the display area AA and the gate driver 20.

In addition, according to the embodiment, dummy pixels may be further disposed between the power lines and the display area AA, but the embodiment is not limited thereto.

In an embodiment, the low potential driving voltage line PL2 may be further disposed on an outside of the gate driver 20.

Meanwhile, in FIG. 21, areas of the shift registers 21 to 26 are illustrated to be identical, but are not limited thereto. For example, areas of the shift registers 21 to 26 may be different from one another, and for example, the area of the first shift register 21 may be the greatest.

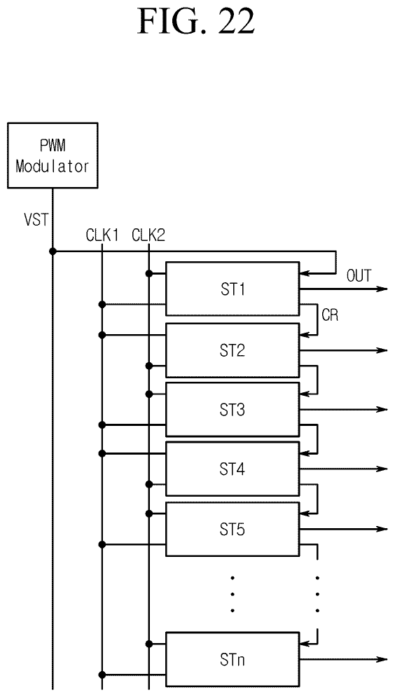

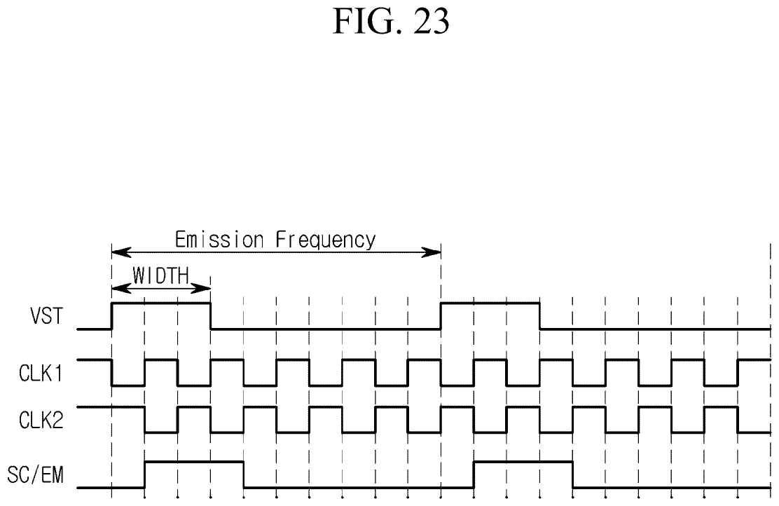

FIG. 22 is a diagram illustrating a connection relationship between the stage circuits of the gate driver according to an embodiment. In more detail, FIG. 22 shows the stage circuits of the fourth shift register 24 or the sixth shift register 26 illustrated in FIG. 21. FIG. 23 is a timing diagram illustrating an example of a signal output by the shift register illustrated in FIG. 22.

Referring to FIG. 22, each of the fourth shift register 24 or the sixth shift register 26 may include a plurality of stage circuits ST1 to STn.

The stage circuits ST1 to STn may be connected dependently. For example, the second stage circuit ST2 may be dependently connected to the first stage circuit ST1, the third stage circuit ST3 may be dependently connected to the second stage circuit ST2, and the fourth stage circuit ST4 may be dependently connected to the third stage circuit ST3. Similarly, the nth stage circuit STn may be dependently connected to the n−1th stage circuit STn-1.

The stage circuits ST1 to STn may have substantially the same or same configuration, but are not limited thereto.

The stage circuits ST1 to STn are configured to receive a start signal VST and clock signals CLK1 and CLK2 applied from the timing controller 10 (FIG. 1). In an illustrated embodiment, two gate clock signals ECLK1 and ECLK2 are applied to the stage circuits ST1 to STn, but the present embodiment is not limited thereto, and a fewer or a greater number of clock signals may be provided to the stage circuits ST1 to STn.

The clock signals CLK1 and CLK2 may be clock signals having the same waveforms and have phases which are shifted at a certain interval. For example, a phase of the first clock signal CLK1 is not shifted, and a phase of the second clock signal CLK2 may be shifted by ½ period with respect to the first clock signal CLK1, but the present embodiment is not limited thereto. The stage circuits ST1 to STn may be configured to receive corresponding one among the clock signals CLK1 and CLK2.

The stage circuit ST1 is configured to receive the start signal VST. Rear-end stage circuits ST2 t STn may receive carry signals CR of front-end stage circuits ST1 to STn−1.

Each of the stage circuits ST1 to STn may output a gate signal or a light emission signal to corresponding output lines OUT. Each of the stage circuits ST1 to STn may be pulled up by one among the clock signals CLK1 and CLK2 and output the light emission signal. In addition, each of the stage circuits ST1 to STn may output the carry signal CR to the next connected stage circuit.

Each of the stage circuits ST1 to STn may be reset by being pulled down by the other among the clock signals CLK1 and CLK2.

In such an embodiment, by modulating a width of the start signal VST, it is possible to output a scan signal or a light emission signal, of which a pulse width is modulated.

Referring to FIG. 23, in a period which corresponds to the light emission frequency during one frame, the start signal VST may be input to the shift registers 24 and 26. The start signal VST may consist of a high level and a low level, each of which having a regular width. In addition, the clock signals CLK1 and CLK2, each of which having a different phase, may be input to the shift registers 24 and 26.

In an embodiment, the shift registers 24 and 26 may output the scan signal or the light emission signal which is turned on in correspondence with the start signal VST. For example, the shift registers 24 and 26 may output the scan signal or the light emission signal, having a width which is the same as a width of the start signal VST and taking the form of a delayed start signal VST. In such an embodiment, periods in which the scan signal or the light emission signal is in a high level and a low level may be the same as the start signal VST.

Therefore, during the light emission period, by applying the start signal VST after modulating a width of the start signal VST to the shift registers 24 and 26, it is possible to modulate a pulse width of the scan signal or the light emission signal. In addition, during the light emission period, by applying the start signal VST for a plurality of number of times to the shift registers 24 and 26, it is possible to allow the scan signal or the light emission signal in a pulse form to be output for a plurality of number of times.

To this end, the gate driver 20 may include a PWM modulator. The PWM modulator may generate a PWM signal based on the gate driving control signal or the light emission driving control signal received from the timing controller 10. For example, the PWM modulator may obtain information on the light emission duty ratio from the gate driving control signal or the light emission driving control signal, for example, a digital brightness value, and generate the PWM signal having the obtained light emission duty ratio. The PWM signal is a pulse signal having a plurality of pulses, and may have a turn-on period and a turn-off period according to the light emission duty ratio. By providing the generated PWM signal to the shift registers 24 and 26 as the start signal VST, it is possible to generate a modulated scan signal or a modulated light emission signal.

The embodiments of the present disclosure have been described with reference to accompanying drawings. Those of ordinary skill in the art will recognize that the present disclosure may be embodied in other specific forms without departing from the spirit or scope of the present disclosure. The described embodiments are to be considered in all respects only as illustrative and not restrictive. The scope of the present disclosure is therefore indicated by the appended claims rather than by the foregoing description. All changes which come within the meaning and range of equivalency of the claims are to be embraced within the scope of the present disclosure.

What is claimed is:

1. A display device, comprising:
a display panel on which a pixel is arranged; a display panel on which a pixel is arranged; and
a data driver configured to apply a data voltage to the pixel through a data line and receive a signal output from the pixel through a readout line,
wherein the data driver comprises:
a sensing driver configured to generate sensing data based on a sensing signal output through the readout line; and
a switching element having one end connected to the readout line and another end connected to the sensing driver or a voltage source in response to a switching control signal.

2. The display device of claim 1,
wherein the switching element electrically connects the readout line and the voltage source to each other during display-driving, and
wherein the switching element electrically connects the readout line and the sensing driver to each other during sensing-driving.

3. The display device of claim 1,
wherein the pixel comprises:
a light emitting diode;
a driving transistor having a first electrode connected to a high potential driving voltage line, a second electrode connected to a first node, and a gate electrode connected to a second node;
a switching transistor connected between the data line and the second node and having a gate electrode configured to receive a first scan signal;
a readout transistor connected between the driving transistor and the readout line and having a gate electrode configured to receive a fourth scan signal; and
a first light emission transistor connected between the high potential driving voltage line and the first electrode of the driving transistor and having a gate electrode configured to receive a first light emission signal.

4. The display device of claim 3,
wherein the readout transistor has one electrode connected to the first electrode or the second electrode of the driving transistor, and another electrode connected to the readout line.

5. The display device of claim 3,
wherein the fourth scan signal is applied such that a turn-on level and a turn-off level are alternately switched at least once during a light emission period in which the first light emission transistor is turned on within one frame.

6. The display device of claim 5,
wherein when the fourth scan signal is applied to the readout transistor in a turn-off level, a driving current flowing from the high potential driving voltage line to the driving transistor is applied to the light emitting diode, and
wherein when the fourth scan signal is applied to the readout transistor in a turn-on level, the driving current is output to the readout line through the readout transistor.

7. The display device of claim 3,
wherein the pixel further includes a second light emission transistor connected between the first node and the light emitting diode and having a gate electrode configured to receive a second light emission signal, and
wherein the second light emission signal is applied such that a turn-on level and a turn-off level are alternately switched at least once during a light emission period in which the first light emission transistor is turned on within one frame.

8. The display device of claim 7,
wherein the fourth scan signal is applied such that a turn-on level and a turn-off level of the fourth scan signal are alternately switched at least once during a light emission period in which the first light emission transistor is turned on within one frame, and
wherein during the light emission period, a turn-off period of the second light emission signal and a turn-on period of the fourth scan signal overlap, and a turn-on period of the second light emission signal and a turn-off period of the fourth scan signal overlap.

9. The display device of claim 7,
wherein the pixel further includes:
an initialization transistor connected between a reference voltage line and the second node and having a gate electrode configured to receive a second scan signal;
an anode initialization transistor connected between the light emitting diode and an initialization voltage line and having a gate electrode configured to receive a third scan signal;
a first capacitor connected between the first node and the second node; and
a second capacitor connected between the high potential driving voltage line and the first node.

10. The display device of claim 9, further comprising a gate driver configured to apply a scan signal and a light emission signal to the pixel,
wherein the display panel includes a display area in which the pixel is disposed and a non-display area disposed adjacent to the display area, and
wherein the gate driver includes:
shift registers disposed on left and right sides of the display area in the non-display area, and configured in a form symmetrical to each other on left and right sides.

11. The display device of claim 10,
wherein the shift registers include:
a first shift register configured to output the first scan signal;
a second shift register configured to output the second scan signal;
a third shift register configured to output the third scan signal;
a fourth shift register configured to output the fourth scan signal;
a fifth shift register configured to output the first light emission signal; and
a sixth shift register configured to output the second light emission signal,
wherein the first to fourth shift registers are disposed to be sequentially away from the display area,
wherein the fifth to sixth shift registers are disposed to be sequentially away from the display area, and
wherein the second to fourth shift registers are disposed to be adjacent to one among the fifth and sixth shift registers.

12. The display device of claim 11,
wherein the gate driver includes:
a modulation driver configured to generate a pulse width modulation signal based on a light emission duty ratio, and apply the pulse width modulation signal to the fourth shift register or the sixth shift register as a start signal.

13. A method for operating a display device, comprising: a display panel on which a pixel is arranged; a gate driver configured to apply a scan signal and a light emission signal to the pixel; and a data driver configured to apply a data voltage to the pixel through a data line and receive a signal output from the pixel through a readout line, wherein the data driver comprises: a sensing driver configured to generate sensing data based on a sensing signal output through the readout line; and a switching element having one end connected to the readout line and another end connected to the sensing driver or a voltage source in response to a switching control signal, and wherein the method comprises:
applying the switching control signal in a first level in a display period; and
applying the switching control signal in a second level which is different from the first level in a sensing period,
wherein during the display period, the switching element electrically connects the readout line and the voltage source to each other in response to the switching control signal in the first level and
wherein during the sensing period, the switching element electrically connects the readout line and the sensing driver to each other in response to the switching control signal in the second level.

14. The method for operating a display device of claim 13,
wherein the pixel comprises:
a light emitting diode;
a driving transistor having a first electrode connected to a high potential driving voltage line, a second electrode connected to a first node, and a gate electrode connected to a second node;
a switching transistor connected between the data line and the second node and having a gate electrode receiving a first scan signal;
an initialization transistor connected between a reference voltage line and the second node and having a gate electrode receiving a second scan signal;
an anode initialization transistor connected between the light emitting diode and an initialization voltage line and having a gate electrode receiving a third scan signal;
a readout transistor connected between the driving transistor and the readout line and having a gate electrode receiving a fourth scan signal;
a first light emission transistor connected between the high potential driving voltage line and the first electrode of the driving transistor and having a gate electrode receiving a first light emission signal;
a second light emission transistor connected between the first node and the light emitting diode and having a gate electrode receiving a second light emission signal;
a first capacitor connected between the first node and the second node; and
a second capacitor connected between the high potential driving voltage line and the first node.

15. The method for operating a display device of claim 14,
wherein the display period comprises:
an initializing operation in which the second scan signal, the third scan signal, and the second light emission signal in a turn-on level are applied;
a sampling operation in which the second light emission signal is switched to a turn-off level and the first light emission signal is applied with a turn-on level;
a programming operation in which the second scan signal and the first light emission signal are switched to a turn-off level, the first scan signal is switched to a turn-on level, and the data driver applies the data voltage;
an on-bias operation in which the first scan signal is switched to a turn-off level and the second light emission signal is switched to a turn-on level; and
a light emitting operation in which the third scan signal is switched to a turn-off level and the first light emission signal is switched to a turn-on level, and
wherein the fourth scan signal is applied such that a turn-on level and a turn-off level of the fourth scan signal are alternately switched at least once during the light emitting operation.

16. The method for operating a display device of claim 15,
wherein the second light emission signal is applied such that a turn-on level and a turn-off level of the second light emission signal are alternately switched at least once during the light emitting operation, and
wherein a turn-off period of the second light emission signal and a turn-on period of the fourth scan signal overlap, and a turn-on period of the second light emission signal and a turn-off period of the fourth scan signal overlap.

17. The method for operating a display device of claim 15,
wherein when the fourth scan signal is applied to the readout transistor in a turn-off level, a driving current flowing from the high potential driving voltage line to the driving transistor is applied to the light emitting diode, and
wherein when the fourth scan signal is applied to the readout transistor in a turn-on level, the driving current is output to the readout line through the readout transistor.

18. The method for operating a display device of claim 14,
wherein the sensing period includes:
an initializing operation in which the second scan signal, the fourth scan signal, and the first light emission signal in a turn-on level are applied, and a sensing initialization voltage is applied to the readout line; and
a sensing operation in which the application of the sensing initialization voltage is stopped and a sensing signal is output to the readout line.

19. A display device, comprising:
a pixel; and
a data driver configured to apply a data voltage to the pixel,
wherein the data driver comprises:
a sensing driver configured to generate sensing data based on a sensing signal output through a readout line; and
a switching element having one end connected to the readout line and another end connected to the sensing driver or a voltage source in response to a switching control signal,
wherein the pixel comprises:
a light emitting diode;
a driving transistor having a first electrode connected to a high potential driving voltage line, a second electrode connected to a first node, and a gate electrode connected to a second node;
a switching transistor connected between a data line and the second node and having a gate electrode configured to receive a first scan signal;
a readout transistor connected between the driving transistor and the readout line and having a gate electrode configured to receive a fourth scan signal; and
a first light emission transistor connected between the high potential driving voltage line and the first electrode of the driving transistor and having a gate electrode configured to receive a first light emission signal.

20. The display device of claim 19,
wherein the pixel further comprises:
a second light emission transistor connected between the first node and the light emitting diode and having a gate electrode configured to receive a second light emission signal;
an initialization transistor connected between a reference voltage line and the second node and having a gate electrode configured to receive a second scan signal;
an anode initialization transistor connected between the light emitting diode and an initialization voltage line and having a gate electrode configured to receive a third scan signal;
a first capacitor connected between the first node and the second node; and
a second capacitor connected between the high potential driving voltage line and the first node.
